(19) United States
(12) Patent Application Publication
(10) Pub. No.: US 2026/0046762 A1
(43) Pub. Date: Feb. 12, 2026

(54) SYNCHRONIZATION SIGNAL DESIGN FOR NETWORK ENERGY SAVINGS

(71) Applicant: QUALCOMM Incorporated, San Diego, CA (US)

(72) Inventors: Jianghong LUO, Skillman, NJ (US); Jae Ho RYU, San Diego, CA (US); Navid ABEDINI, Basking Ridge, NJ (US)

(21) Appl. No.: 18/797,335

(22) Filed: Aug. 7, 2024

(51) Int. Cl. H04W 52/02; H04W 48/10; H04W 56/00

(52) U.S. Cl. CPC H04W 52/0206; H04W 48/10; H04W 56/001

(57) ABSTRACT

Methods, systems, and devices for wireless communications are described. A user equipment (UE) may receive a synchronization signal for a cell. The synchronization signal may include a discovery reference signal identifier (DRSIdx) corresponding to an index of the synchronization signal within a burst of synchronization signals. The UE may transmit a wake up signal (WUS) via resources of the cell that are determined based on the DRSIdx. The UE may receive a PBCH of the cell based on transmitting the WUS.

### FIELD OF TECHNOLOGY

The present disclosure relates to wireless communications, including synchronization signal design for network energy savings.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

### SUMMARY

The systems, methods, and devices of this disclosure each have several innovative aspects, no single one of which is solely responsible for the desirable attributes disclosed herein.

A method by a user equipment (UE) is described. The method may include receiving a synchronization signal for a cell, where the synchronization signal includes a discovery signal identifier corresponding to an index of the synchronization signal within a burst of synchronization signals, transmitting a wake up signal (WUS) via resources of the cell that are determined based on the discovery signal identifier, and receiving a physical broadcast channel (PBCH) of the cell based on transmitting the WUS.

A UE is described. The UE may include one or more memories storing processor executable code, and one or more processors coupled with the one or more memories. The one or more processors may individually or collectively be operable to execute the code to cause the UE to receive a synchronization signal for a cell, where the synchronization signal includes a discovery signal identifier corresponding to an index of the synchronization signal within a burst of synchronization signals, transmit a WUS via resources of the cell that are determined based on the discovery signal identifier, and receive a PBCH of the cell based on transmitting the WUS.

Another UE is described. The UE may include means for receiving a synchronization signal for a cell, where the synchronization signal includes a discovery signal identifier corresponding to an index of the synchronization signal within a burst of synchronization signals, means for transmitting a WUS via resources of the cell that are determined based on the discovery signal identifier, and means for receiving a PBCH of the cell based on transmitting the WUS.

A non-transitory computer-readable medium storing code is described. The code may include instructions executable by one or more processors to receive a synchronization signal for a cell, where the synchronization signal includes a discovery signal identifier corresponding to an index of the synchronization signal within a burst of synchronization signals, transmit a WUS via resources of the cell that are determined based on the discovery signal identifier, and receive a PBCH of the cell based on transmitting the WUS.

Some examples of the method, UEs, and non-transitory computer-readable medium described herein may further include operations, features, means, or instructions for receiving, via the synchronization signal for the cell, a virtual cell identifier of the cell, where the virtual cell identifier may be associated with a physical cell identifier (PCI) of the cell.

In some examples of the method, UEs, and non-transitory computer-readable medium described herein, the PBCH includes a partial PCI and the PCI may be determined based on the partial PCI and the virtual cell identifier.

Some examples of the method, UEs, and non-transitory computer-readable medium described herein may further include operations, features, means, or instructions for receiving, from an anchor cell, a set of PCIs corresponding to one or more cells associated with the anchor cell.

In some examples of the method, UEs, and non-transitory computer-readable medium described herein, the virtual cell identifier includes a second index, and the second index indicates the PCI in the set of PCIs.

In some examples of the method, UEs, and non-transitory computer-readable medium described herein, the set of PCIs corresponding to the one or more cells may be divided into a set of multiple subgroups and the virtual cell identifier indicates a subgroup associated with the PCI.

In some examples of the method, UEs, and non-transitory computer-readable medium described herein, the PCI may be mapped to a first network identifier (NID) and a second NID, and the virtual cell identifier includes the first NID or the second NID.

In some examples of the method, UEs, and non-transitory computer-readable medium described herein, the virtual cell identifier corresponds to a set of most significant bits of the PCI or a set of least significant bits of the PCI.

In some examples of the method, UEs, and non-transitory computer-readable medium described herein, a sequence associated with the synchronization signal may be based on the virtual cell identifier and the discovery signal identifier.

In some examples of the method, UEs, and non-transitory computer-readable medium described herein, the virtual cell identifier and the discovery signal identifier may be mapped to a first NID and a second NID associated with the synchronization signal.

In some examples of the method, UEs, and non-transitory computer-readable medium described herein, a demodulation reference signal scrambling seed associated with the PBCH may be based on the virtual cell identifier or the discovery signal identifier.

In some examples of the method, UEs, and non-transitory computer-readable medium described herein, the PBCH includes a PCI.

Some examples of the method, UEs, and non-transitory computer-readable medium described herein may further include operations, features, means, or instructions for receiving, from an anchor cell, an indication of an offset, an uplink WUS length, and a synchronization signal length, where the resources of the cell may be based on the offset, the uplink WUS length, and the synchronization signal length.

In some examples of the method, UEs, and non-transitory computer-readable medium described herein, the burst of synchronization signals may be TDMed based on a time gap, FDMed based on a frequency offset, or both.

Some examples of the method, UEs, and non-transitory computer-readable medium described herein may further include operations, features, means, or instructions for receiving, from an anchor cell, an indication of the time gap, the frequency offset, or both.

Some examples of the method, UEs, and non-transitory computer-readable medium described herein may further include operations, features, means, or instructions for receiving, from an anchor cell, an indication of a packing pattern associated with the burst of synchronization signals, where receiving the synchronization signal for the cell may be based on the packing pattern.

Some examples of the method, UEs, and non-transitory computer-readable medium described herein may further include operations, features, means, or instructions for transmitting a second WUS via second resources of the cell that may be determined based on the discovery signal identifier, where a transmit power associated with the second WUS may be based on the second WUS being a retransmission of the WUS.

In some examples of the method, UEs, and non-transitory computer-readable medium described herein, the WUS includes a single signal.

In some examples of the method, UEs, and non-transitory computer-readable medium described herein, the WUS includes a set of multiple signals.

In some examples of the method, UEs, and non-transitory computer-readable medium described herein, data associated with the PBCH may be based on the WUS.

In some examples of the method, UEs, and non-transitory computer-readable medium described herein, the WUS includes an indication of a mobility state at the UE.

In some examples of the method, UEs, and non-transitory computer-readable medium described herein, to receiving the PBCH may include operations, features, means, or instructions for receiving the PBCH via one or more transmit beams at a network node associated with the cell, where at least one of the one or more transmit beams may be quasi collocated (QCL) with the synchronization signal.

A method by a network node is described. The method may include outputting a synchronization signal for a cell, where the synchronization signal includes a discovery signal identifier corresponding to an index of the synchronization signal within a burst of synchronization signals, obtaining a WUS via resources of the cell that are determined based on the discovery signal identifier, and outputting a PBCH of the cell based on obtaining the WUS.

A network node is described. The network node may include one or more memories storing processor executable code, and one or more processors coupled with the one or more memories. The one or more processors may individually or collectively be operable to execute the code to cause the network node to output a synchronization signal for a cell, where the synchronization signal includes a discovery signal identifier corresponding to an index of the synchronization signal within a burst of synchronization signals, obtain a WUS via resources of the cell that are determined based on the discovery signal identifier, and output a PBCH of the cell based on obtaining the WUS.

Another network node is described. The network node may include means for outputting a synchronization signal for a cell, where the synchronization signal includes a discovery signal identifier corresponding to an index of the synchronization signal within a burst of synchronization signals, means for obtaining a WUS via resources of the cell that are determined based on the discovery signal identifier, and means for outputting a PBCH of the cell based on obtaining the WUS.

A non-transitory computer-readable medium storing code is described. The code may include instructions executable by one or more processors to output a synchronization signal for a cell, where the synchronization signal includes a discovery signal identifier corresponding to an index of the synchronization signal within a burst of synchronization signals, obtain a WUS via resources of the cell that are determined based on the discovery signal identifier, and output a PBCH of the cell based on obtaining the WUS.

In some examples of the method, network nodes, and non-transitory computer-readable medium described herein, output, via the synchronization signal for the cell, a virtual cell identifier of the cell, where the virtual cell identifier may be associated with a PCI of the cell.

Some examples of the method, network nodes, and non-transitory computer-readable medium described herein may further include operations, features, means, or instructions for obtaining, from an anchor cell, an indication of an offset, an uplink WUS length, and a synchronization signal length, where the resources of the cell may be based on the offset, the uplink WUS length, and the synchronization signal length.

In some examples of the method, network nodes, and non-transitory computer-readable medium described herein, output, as an anchor cell, an indication of an offset, an uplink WUS length, and a synchronization signal length, where the resources of the cell may be based on the offset, the uplink WUS length, and the synchronization signal length.

Some examples of the method, network nodes, and non-transitory computer-readable medium described herein may further include operations, features, means, or instructions for obtaining, from an anchor cell, an indication of a packing pattern associated with the burst of synchronization signals, where outputting the synchronization signal for the cell may be based on the packing pattern.

In some examples of the method, network nodes, and non-transitory computer-readable medium described herein, output, as an anchor cell, an indication of a packing pattern associated with the burst of synchronization signals, where outputting the synchronization signal for the cell may be based on the packing pattern.

Details of one or more implementations of the subject matter described in this disclosure are set forth in the accompanying drawings and the description below. Other features, aspects, and advantages will become apparent from the description, the drawings, and the claims. Note that the relative dimensions of the following figures may not be drawn to scale.

### BRIEF DESCRIPTION OF THE DRAWINGS

FIG. 1 shows an example of a wireless communications system that supports synchronization signal design for network energy savings in accordance with one or more aspects of the present disclosure.

FIG. 2 shows an example of a wireless communications system that supports synchronization signal design for network energy savings in accordance with one or more aspects of the present disclosure.

FIG. 3A shows an example of a communications timeline that supports synchronization signal design for network energy savings in accordance with one or more aspects of the present disclosure.

FIG. 3B shows an example of a communications timeline that supports synchronization signal design for network energy savings in accordance with one or more aspects of the present disclosure.

FIG. 4 shows an example of a process flow that supports synchronization signal design for network energy savings in accordance with one or more aspects of the present disclosure.

FIGS. 5 and 6 show block diagrams of devices that support synchronization signal design for network energy savings in accordance with one or more aspects of the present disclosure.

FIG. 7 shows a block diagram of a communications manager that supports synchronization signal design for network energy savings in accordance with one or more aspects of the present disclosure.

FIG. 8 shows a diagram of a system including a device that supports synchronization signal design for network energy savings in accordance with one or more aspects of the present disclosure.

FIGS. 9 and 10 show block diagrams of devices that support synchronization signal design for network energy savings in accordance with one or more aspects of the present disclosure.

FIG. 11 shows a block diagram of a communications manager that supports synchronization signal design for network energy savings in accordance with one or more aspects of the present disclosure.

FIG. 12 shows a diagram of a system including a device that supports synchronization signal design for network energy savings in accordance with one or more aspects of the present disclosure.

FIGS. 13 through 17 show flowcharts illustrating methods that support synchronization signal design for network energy savings in accordance with one or more aspects of the present disclosure.

### DETAILED DESCRIPTION

In some wireless communications systems, a network node may transmit light synchronization signal blocks (SSBs) and on-demand SSBs. The light SSBs may be associated with reduced communication resources. The light SSBs may include a burst of synchronization signals. In some examples, a physical broadcast channel (PBCH) associated with a light SSB may be transmitted on-demand (e.g., via the on-demand SSB). For example, the network node may transmit a PBCH in response to receiving a wake up signal (WUS) from a user equipment (UE). The UE may transmit the WUS via uplink WUS resources associated with a synchronization signal. For example, the network node may indicate uplink WUS resources associated with each synchronization signal. In some examples, the uplink WUS resources may be a fixed temporal offset from the synchronization signal. To accommodate the fixed offset and provide communication resources for each synchronization signal, the network node may inefficiently schedule synchronization signal bursts with temporal gaps between synchronization signals. The temporal gaps may decrease efficient use of communication resources and increase power consumption at the network node.

According to techniques described herein, the UE may receive a synchronization signal for a cell associated with the network node, and the UE may identify uplink WUS resources associated with the synchronization signal based on a variable offset. The synchronization signal may include a discovery reference signal identifier (DRSIdx) corresponding to an index of the synchronization signal within the burst of synchronization signals. The DRSIdx may enable consecutive synchronization signals to each be associated with unique uplink WUS resources. The UE may determine the set of uplink WUS resources associated with the synchronization signal based on the DRSIdx. For example, the variable offset associated with each set of uplink WUS resources may be based on the DRSIdx. The variable offset may reduce temporal gaps between synchronization signals, increasing efficient use of communication resources and decreasing power consumption at the network node.

The UE may transmit the WUS via the set of communication resources associated with the synchronization signal. In response to transmitting the WUS, the UE may receive the PBCH of the cell. In some cases, the UE may determine a physical cell identifier (PCI) based on the PBCH.

Aspects of the disclosure are initially described in the context of wireless communications systems. Additional aspects of the disclosure are described in the context of communications timelines and process flows. Aspects of the disclosure are further illustrated by and described with reference to apparatus diagrams, system diagrams, and flowcharts that relate to synchronization signal design for network energy savings.

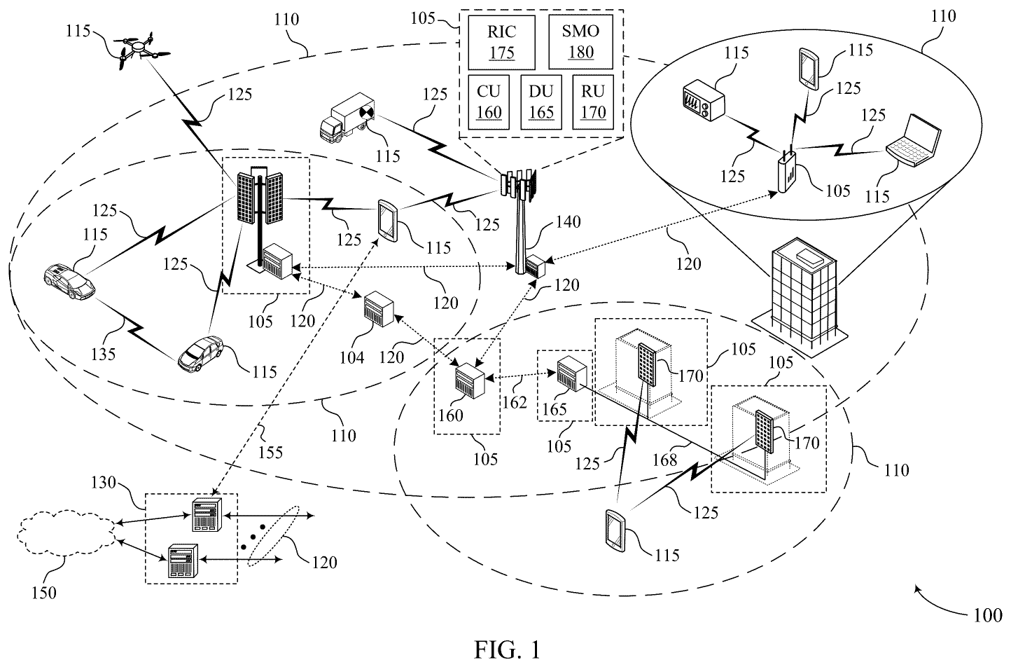

FIG. 1 shows an example of a wireless communications system 100 that supports synchronization signal design for network energy savings in accordance with one or more aspects of the present disclosure. The wireless communications system 100 may include one or more devices, such as one or more network devices (e.g., network nodes 105 or network entities), one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network nodes 105 may be dispersed throughout a geographic area to form the wireless communications system 100 and may include devices in different forms or having different capabilities. In various examples, a network node 105 may be referred to as a network element, a mobility element, a radio access network (RAN) node, or network equipment, among other nomenclature. In some examples, network nodes 105 and UEs 115 may wirelessly communicate via communication link(s) 125 (e.g., a radio frequency (RF) access link). For example, a network node 105 may support a coverage area 110 (e.g., a geographic coverage area) over which the UEs 115 and the network node 105 may establish the communication link(s) 125. The coverage area 110 may be an example of a geographic area over which a network node 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices in the wireless communications system 100 (e.g., other wireless communication devices, including UEs 115 or network nodes 105), as shown in FIG. 1.

As described herein, a node of the wireless communications system 100, which may be referred to as a network entity, or a wireless node, may be a network node 105 (e.g., any network node described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network node 105. As another example, a first node may be configured to communicate with a second node or a third node. In one aspect of this example, the first node may be a UE 115, the second node may be a network node 105, and the third node may be a UE 115. In another aspect of this example, the first node may be a UE 115, the second node may be a network node 105, and the third node may be a network node 105. In yet other aspects of this example, the first, second, and third nodes may be different relative to these examples. Similarly, reference to a UE 115, network node 105, apparatus, device, computing system, or the like may include disclosure of the UE 115, network node 105, apparatus, device, computing system, or the like being a node. For example, disclosure that a UE 115 is configured to receive information from a network node 105 also discloses that a first node is configured to receive information from a second node.

In some examples, network nodes 105 may communicate with a core network 130, or with one another, or both. For example, network nodes 105 may communicate with the core network 130 via backhaul communication link(s) 120 (e.g., in accordance with an S1, N2, N3, or other interface protocol). In some examples, network nodes 105 may communicate with one another via backhaul communication link(s) 120 (e.g., in accordance with an X2, Xn, or other interface protocol) either directly (e.g., directly between network nodes 105) or indirectly (e.g., via the core network 130). In some examples, network nodes 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication link(s) 120, midhaul communication links 162, or fronthaul communication links 168 may be or include one or more wired links (e.g., an electrical link, an optical fiber link) or one or more wireless links (e.g., a radio link, a wireless optical link), among other examples or various combinations thereof. A UE 115 may communicate with the core network 130 via a communication link 155.

One or more of the network nodes 105 or network equipment described herein may include or may be referred to as a base station 140 (e.g., a base transceiver station, a radio base station, an NR base station, an access point, a radio transceiver, a NodeB, an eNodeB (eNB), a next-generation NodeB or giga-NodeB (either of which may be referred to as a gNB), a 5G NB, a next-generation eNB (ng-eNB), a Home NodeB, a Home eNodeB, or other suitable terminology). In some examples, a network node 105 (e.g., a base station 140) may be implemented in an aggregated (e.g., monolithic, standalone) base station architecture, which may be configured to utilize a protocol stack that is physically or logically integrated within one network node (e.g., a network node 105 or a single RAN node, such as a base station 140).

In some examples, a network node 105 may be implemented in a disaggregated architecture (e.g., a disaggregated base station architecture, a disaggregated RAN architecture), which may be configured to utilize a protocol stack that is physically or logically distributed among multiple network nodes (e.g., network nodes 105), such as an integrated access and backhaul (IAB) network, an open RAN (O-RAN) (e.g., a network configuration sponsored by the O-RAN Alliance), or a virtualized RAN (vRAN) (e.g., a cloud RAN (C-RAN)). For example, a network node 105 may include one or more of a central unit (CU), such as a CU 160, a distributed unit (DU), such as a DU 165, a radio unit (RU), such as an RU 170, a RAN Intelligent Controller (RIC), such as an RIC 175 (e.g., a Near-Real Time RIC (Near-RT RIC), a Non-Real Time RIC (Non-RT RIC)), a Service Management and Orchestration (SMO) system, such as an SMO system 180, or any combination thereof. An RU 170 may also be referred to as a radio head, a smart radio head, a remote radio head (RRH), a remote radio unit (RRU), or a transmission reception point (TRP). One or more components of the network nodes 105 in a disaggregated RAN architecture may be co-located, or one or more components of the network nodes 105 may be located in distributed locations (e.g., separate physical locations). In some examples, one or more of the network nodes 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, or any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaptation protocol (SDAP), Packet Data Convergence Protocol (PDCP)). The CU 160 (e.g., one or more CUs) may be connected to a DU 165 (e.g., one or more DUs) or an RU 170 (e.g., one or more RUs), or some combination thereof, and the DUs 165, RUs 170, or both may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or multiple different RUs, such as an RU 170). In some cases, a functional split between a CU 160 and a DU 165 or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to a DU 165 via a midhaul communication link 162 (e.g., F1, F1-c, F1-u), and a DU 165 may be connected to an RU 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network nodes (e.g., one or more of the network nodes 105) that are in communication via such communication links.

In some wireless communications systems (e.g., the wireless communications system 100), infrastructure and spectral resources for radio access may support wireless backhaul link capabilities to supplement wired backhaul connections, providing an IAB network architecture (e.g., to a core network 130). In some cases, in an IAB network, one or more of the network nodes 105 (e.g., network nodes 105 or IAB node(s) 104) may be partially controlled by each other. The IAB node(s) 104 may be referred to as a donor entity or an IAB donor. A DU 165 or an RU 170 may be partially controlled by a CU 160 associated with a network node 105 or base station 140 (such as a donor network node or a donor base station). The one or more donor entities (e.g., IAB donors) may be in communication with one or more additional devices (e.g., IAB node(s) 104) via supported access and backhaul links (e.g., backhaul communication link(s) 120). IAB node(s) 104 may include an IAB mobile termination (IAB-MT) controlled (e.g., scheduled) by one or more DUs (e.g., DUs 165) of a coupled IAB donor. An IAB-MT may be equipped with an independent set of antennas for relay of communications with UEs 115 or may share the same antennas (e.g., of an RU 170) of IAB node(s) 104 used for access via the DU 165 of the IAB node(s) 104 (e.g., referred to as virtual IAB-MT (vIAB-MT)). In some examples, the IAB node(s) 104 may include one or more DUs (e.g., DUs 165) that support communication links with additional entities (e.g., IAB node(s) 104, UEs 115) within the relay chain or configuration of the access network (e.g., downstream). In such cases, one or more components of the disaggregated RAN architecture (e.g., the IAB node(s) 104 or components of the IAB node(s) 104) may be configured to operate according to the techniques described herein.

In the case of the techniques described herein applied in the context of a disaggregated RAN architecture, one or more components of the disaggregated RAN architecture may be configured to support test as described herein. For example, some operations described as being performed by a UE 115 or a network node 105 (e.g., a base station 140) may additionally, or alternatively, be performed by one or more components of the disaggregated RAN architecture (e.g., components such as an IAB node, a DU 165, a CU 160, an RU 170, an RIC 175, an SMO system 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IOT) device, an Internet of Everything (IoE) device, or a machine type communications (MTC) device, among other examples, which may be implemented in various objects such as appliances, vehicles, or meters, among other examples.

The UEs 115 described herein may be able to communicate with various types of devices, such as UEs 115 that may sometimes operate as relays, as well as the network nodes 105 and the network equipment including macro eNBs or gNBs, small cell eNBs or gNBs, or relay base stations, among other examples, as shown in FIG. 1.

The UEs 115 and the network nodes 105 may wirelessly communicate with one another via the communication link(s) 125 (e.g., one or more access links) using resources associated with one or more carriers. The term “carrier” may refer to a set of RF spectrum resources having a defined PHY layer structure for supporting the communication link(s) 125. For example, a carrier used for the communication link(s) 125 may include a portion of an RF spectrum band (e.g., a bandwidth part (BWP)) that is operated according to one or more PHY layer channels for a given RAT (e.g., LTE, LTE-A, LTE-A Pro, NR). Each PHY layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network node 105 and other devices may refer to communication between the devices and any portion (e.g., entity, sub-entity) of a network node 105. For example, the terms “transmitting,” “receiving,” or “communicating,” when referring to a network node 105, may refer to any portion of a network node 105 (e.g., a base station 140, a CU 160, a DU 165, a RU 170) of a RAN communicating with another device (e.g., directly or via one or more other network nodes, such as one or more of the network nodes 105).

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

The time intervals for the network nodes 105 or the UEs 115 may be expressed in multiples of a basic time unit which may, for example, refer to a sampling period of Tₛ=1/(Δfₘₐₓ·N_{f}) seconds, for which Δfₘₐₓ may represent a supported subcarrier spacing, and N_{f} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems, such as the wireless communications system 100, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (STTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to UEs 115 (e.g., one or more UEs) or may include UE-specific search space sets for sending control information to a UE 115 (e.g., a specific UE).

A network node 105 may provide communication coverage via one or more cells, for example a macro cell, a small cell, a hot spot, or other types of cells, or any combination thereof. The term “cell” may refer to a logical communication entity used for communication with a network node 105 (e.g., using a carrier) and may be associated with an identifier for distinguishing neighboring cells (e.g., a PCI (PCID), a virtual cell identifier (VCID)). In some examples, a cell also may refer to a coverage area 110 or a portion of a coverage area 110 (e.g., a sector) over which the logical communication entity operates. Such cells may range from smaller areas (e.g., a structure, a subset of structure) to larger areas depending on various factors such as the capabilities of the network node 105. For example, a cell may be or include a building, a subset of a building, or exterior spaces between or overlapping with coverage areas 110, among other examples.

A macro cell generally covers a relatively large geographic area (e.g., several kilometers in radius) and may allow unrestricted access by the UEs 115 with service subscriptions with the network provider supporting the macro cell. A small cell may be associated with a network node 105 operating with lower power (e.g., a base station 140 operating with lower power) relative to a macro cell, and a small cell may operate using the same or different (e.g., licensed, unlicensed) frequency bands as macro cells. Small cells may provide unrestricted access to the UEs 115 with service subscriptions with the network provider or may provide restricted access to the UEs 115 having an association with the small cell (e.g., the UEs 115 in a closed subscriber group (CSG), the UEs 115 associated with users in a home or office). A network node 105 may support one or more cells and may also support communications via the one or more cells using one or multiple component carriers.

In some examples, a carrier may support multiple cells, and different cells may be configured according to different protocol types (e.g., MTC, narrowband IoT (NB-IOT), enhanced mobile broadband (eMBB)) that may provide access for different types of devices.

In some examples, a network node 105 (e.g., a base station 140, an RU 170) may be movable and therefore provide communication coverage for a moving coverage area, such as the coverage area 110. In some examples, coverage areas 110 (e.g., different coverage areas) associated with different technologies may overlap, but the coverage areas 110 (e.g., different coverage areas) may be supported by the same network node (e.g., a network node 105). In some other examples, overlapping coverage areas, such as a coverage area 110, associated with different technologies may be supported by different network nodes (e.g., the network nodes 105). The wireless communications system 100 may include, for example, a heterogeneous network in which different types of the network nodes 105 support communications for coverage areas 110 (e.g., different coverage areas) using the same or different RATs.

Some UEs 115, such as MTC or IoT devices, may be relatively low cost or low complexity devices and may provide for automated communication between machines (e.g., via Machine-to-Machine (M2M) communication). M2M communication or MTC may refer to data communication technologies that allow devices to communicate with one another or a network node 105 (e.g., a base station 140) without human intervention. In some examples, M2M communication or MTC may include communications from devices that integrate sensors or meters to measure or capture information and relay such information to a central server or application program that uses the information or presents the information to humans interacting with the application program. Some UEs 115 may be designed to collect information or enable automated behavior of machines or other devices. Examples of applications for MTC devices include smart metering, inventory monitoring, water level monitoring, equipment monitoring, healthcare monitoring, wildlife monitoring, weather and geological event monitoring, fleet management and tracking, remote security sensing, physical access control, and transaction-based business charging.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs (e.g., one or more of the UEs 115) via a device-to-device (D2D) communication link, such as a D2D communication link 135 (e.g., in accordance with a peer-to-peer (P2P), D2D, or sidelink protocol). In some examples, one or more UEs 115 of a group that are performing D2D communications may be within the coverage area 110 of a network node 105 (e.g., a base station 140, an RU 170), which may support aspects of such D2D communications being configured by (e.g., scheduled by) the network node 105. In some examples, one or more UEs 115 of such a group may be outside the coverage area 110 of a network node 105 or may be otherwise unable to or not configured to receive transmissions from a network node 105. In some examples, groups of the UEs 115 communicating via D2D communications may support a one-to-many (1:M) system in which each UE 115 transmits to one or more of the UEs 115 in the group. In some examples, a network node 105 may facilitate the scheduling of resources for D2D communications. In some other examples, D2D communications may be carried out between the UEs 115 without an involvement of a network node 105.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network nodes 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than one hundred kilometers) compared to communications using the smaller frequencies and longer waves of the high frequency (HF) or very high frequency (VHF) portion of the spectrum below 300 MHZ.

The wireless communications system 100 may utilize both licensed and unlicensed RF spectrum bands. For example, the wireless communications system 100 may employ License Assisted Access (LAA), LTE-Unlicensed (LTE-U) RAT, or NR technology using an unlicensed band such as the 5 GHz industrial, scientific, and medical (ISM) band. While operating using unlicensed RF spectrum bands, devices such as the network nodes 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network node 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network node 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network node 105 may be located at diverse geographic locations. A network node 105 may include an antenna array with a set of rows and columns of antenna ports that the network node 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

The network nodes 105 or the UEs 115 may use MIMO communications to exploit multipath signal propagation and increase spectral efficiency by transmitting or receiving multiple signals via different spatial layers. Such techniques may be referred to as spatial multiplexing. The multiple signals may, for example, be transmitted by the transmitting device via different antennas or different combinations of antennas. Likewise, the multiple signals may be received by the receiving device via different antennas or different combinations of antennas. Each of the multiple signals may be referred to as a separate spatial stream and may carry information associated with the same data stream (e.g., the same codeword) or different data streams (e.g., different codewords). Different spatial layers may be associated with different antenna ports used for channel measurement and reporting. MIMO techniques include single-user MIMO (SU-MIMO), for which multiple spatial layers are transmitted to the same receiving device, and multiple-user MIMO (MU-MIMO), for which multiple spatial layers are transmitted to multiple devices.

Beamforming, which may also be referred to as spatial filtering, directional transmission, or directional reception, is a signal processing technique that may be used at a transmitting device or a receiving device (e.g., a network node 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

A network node 105 or a UE 115 may use beam sweeping techniques as part of beamforming operations. For example, a network node 105 (e.g., a base station 140, an RU 170) may use multiple antennas or antenna arrays (e.g., antenna panels) to conduct beamforming operations for directional communications with a UE 115. Some signals (e.g., synchronization signals, reference signals, beam selection signals, or other control signals) may be transmitted by a network node 105 multiple times along different directions. For example, the network node 105 may transmit a signal according to different beamforming weight sets associated with different directions of transmission. Transmissions along different beam directions may be used to identify (e.g., by a transmitting device, such as a network node 105, or by a receiving device, such as a UE 115) a beam direction for later transmission or reception by the network node 105.

Some signals, such as data signals associated with a particular receiving device, may be transmitted by a transmitting device (e.g., a network node 105 or a UE 115) along a single beam direction (e.g., a direction associated with the receiving device, such as another network node 105 or UE 115). In some examples, the beam direction associated with transmissions along a single beam direction may be determined based on a signal that was transmitted along one or more beam directions. For example, a UE 115 may receive one or more of the signals transmitted by the network node 105 along different directions and may report to the network node 105 an indication of the signal that the UE 115 received with a highest signal quality or an otherwise acceptable signal quality.

In some examples, transmissions by a device (e.g., by a network node 105 or a UE 115) may be performed using multiple beam directions, and the device may use a combination of digital precoding or beamforming to generate a combined beam for transmission (e.g., from a network node 105 to a UE 115). The UE 115 may report feedback that indicates precoding weights for one or more beam directions, and the feedback may correspond to a configured set of beams across a system bandwidth or one or more sub-bands. The network node 105 may transmit a reference signal (e.g., a cell-specific reference signal (CRS), a channel state information reference signal (CSI-RS)), which may be precoded or unprecoded. The UE 115 may provide feedback for beam selection, which may be a precoding matrix indicator (PMI) or codebook-based feedback (e.g., a multi-panel type codebook, a linear combination type codebook, a port selection type codebook). Although these techniques are described with reference to signals transmitted along one or more directions by a network node 105 (e.g., a base station 140, an RU 170), a UE 115 may employ similar techniques for transmitting signals multiple times along different directions (e.g., for identifying a beam direction for subsequent transmission or reception by the UE 115) or for transmitting a signal along a single direction (e.g., for transmitting data to a receiving device).

A receiving device (e.g., a UE 115) may perform reception operations in accordance with multiple receive configurations (e.g., directional listening) when receiving various signals from a transmitting device (e.g., a network node 105), such as synchronization signals, reference signals, beam selection signals, or other control signals. For example, a receiving device may perform reception in accordance with multiple receive directions by receiving via different antenna subarrays, by processing received signals according to different antenna subarrays, by receiving according to different receive beamforming weight sets (e.g., different directional listening weight sets) applied to signals received at multiple antenna elements of an antenna array, or by processing received signals according to different receive beamforming weight sets applied to signals received at multiple antenna elements of an antenna array, any of which may be referred to as “listening” according to different receive configurations or receive directions. In some examples, a receiving device may use a single receive configuration to receive along a single beam direction (e.g., when receiving a data signal). The single receive configuration may be aligned along a beam direction determined based on listening according to different receive configuration directions (e.g., a beam direction determined to have a highest signal strength, highest signal-to-noise ratio (SNR), or otherwise acceptable signal quality based on listening according to multiple beam directions).

Devices in wireless communications system 100 may communicate over unlicensed spectrum, such as the 5 GHz band, the 2.4 GHz band, the 60 GHz band, the 3.6 GHz band, and/or the 900 MHz band. The unlicensed spectrum may also include other frequency bands.

According to techniques described herein, the UE 115 may receive a synchronization signal for a cell associated with the network node 105, and the UE 115 may identify uplink WUS resources associated with the synchronization signal based on a variable offset. The synchronization signal may include a DRSIdx corresponding to an index of the synchronization signal within the burst of synchronization signals. The DRSIdx may enable consecutive synchronization signals to each be associated with unique uplink WUS resources. The UE 115 may determine the set of uplink WUS resource associated with the synchronization signal based on the DRSIdx. For example, the variable offset associated with each set of uplink WUS resources may be based on the DRSIdx. The variable offset may reduce temporal gaps between synchronization signals, increasing efficient use of communication resources and decreasing power consumption at the network node.

The UE 115 may transmit the WUS via the set of communication resources associated with the synchronization signal. In response to transmitting the WUS, the UE 115 may receive the PBCH of the cell. In some cases, the UE 115 may determine a PCI based on the PBCH.

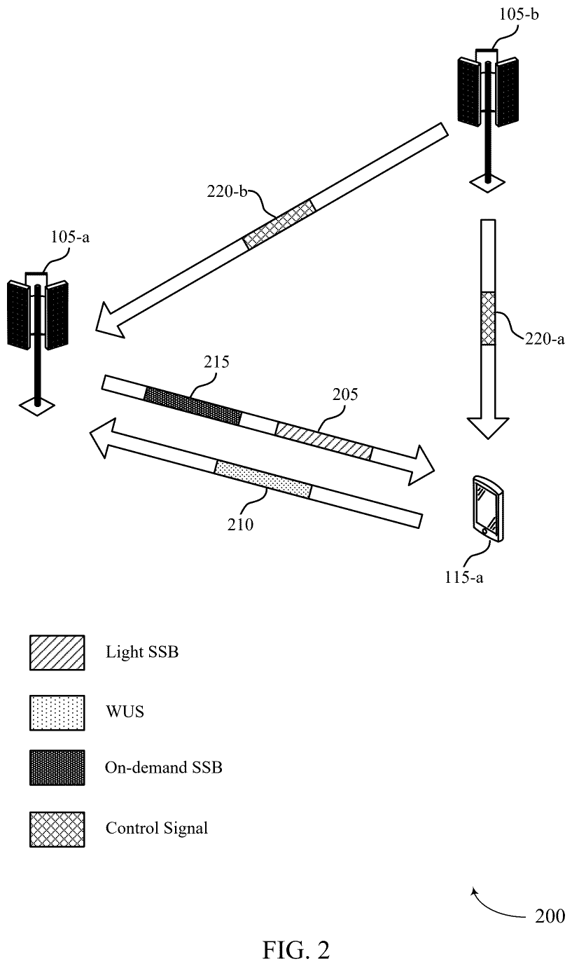

FIG. 2 shows an example of a wireless communications system 200 that supports synchronization signal design for network energy savings in accordance with one or more aspects of the present disclosure. In some examples, wireless communications system 200 may implement aspects of wireless communications system 100. For example, a UE 115-a may represent an example of a UE, such as the UEs 115 described with reference to FIG. 1. A network node 105-a and a network node 105-b may represent an example of a network node, such as the network nodes 105 described with reference to FIG. 1. The UE 115-a may communicate with the network node 105-a via an active cell of the network node 105-a. For example, the UE 115-a may receive a light SSB 205, and the UE 115-a may transmit a WUS 210 to the network node 105-a. The network node 105-b may transmit an on-demand SSB 215 based on receiving the WUS 210. The UE 115-a may receive control signal 220-a from an anchor cell of the network node 105-b. In some cases, the network node 105-a and the network node 105-b may be the same network node 105. In some cases, the network node 105-a may receive control signal 220-b from the anchor cell of the network node 105-b.

In some wireless communications systems, a network node 105-a may transmit an SSB to a UE 115-a. The SSB may include synchronization signals (e.g., a primary synchronization signal (PSS) and a secondary synchronization signal (SSS)) and a PBCH. The UE 115-a may utilize the SSB to synchronize with the network node 105-a and receive configuration information from the network node 105-a. In some examples, the UE 115-a may use the SSB to identify timing resources, frequency resources, a cell identifier (ID), or perform beam acquisition. In some examples, the UE 115-a may perform a signal quality measurement on a synchronization signal of the SSB. In some examples, the UE 115-a may perform automatic gain control (AGC) and time or frequency tracking loops based on the SSBs. In some examples, the UE 115-a may identify a root quasi co-located (QCL) source for signals or channels based on the SSB.

The synchronization signal may indicate a PCI (e.g., a value 0 through 1007). The PCI may be based on a first network ID (NID) and a second NID (e.g., PCI=3*NID1+NID2, NID1: {0, . . . 335}, NID2: {0,1,2}). For example, the PSS sequence generation may be based on the second NID. The SSS sequence generation may be based on both the first NID and the second NID. The UE 115-a may utilize the PCI to distinguish a synchronization signal of the active cell from the synchronization signals of neighboring cells.

Transmitting a full SSB periodically may increase power consumption at the network node 105-a. To decrease power consumption, the network node 105-a may support light SSBs 205 or light system information blocks (SIBs) and on-demand SSBs 215 or on-demand SIBs). For example, rather than sending an SSB periodically, a cell of the network node 105-a may include the capability to transmit a resource-efficient lighter version of an SSB (e.g., a light SSB 205). The network node 105-a may transmit the light SSB including the synchronization signal (e.g., PSS or SSS) and excluding the PBCH. In some examples, the network node 105-a may transmit or deliver the on-demand SSB 215 based on a WUS 210 from the UE 115-a. For example, the network node 105-a may transmit the on-demand SSB 215 including the on-demand PBCH based on a WUS 210 from the UE 115-a. The light SSBs 205 and the on-demand SSB 215 may offer more flexibility in resource management within a network.

The light SSB 205 may include a PSS, an SSS, a channel state information reference signal (CSI-RS), or a tracking reference signal (TRS). The on-demand SSB 215 may include an SSB, a PBCH, a PSS, a SSS, physical downlink control channel (PDCCH) and physical downlink shared channel (PDSCH) (e.g., that carries part of an SIB or master information block (MIB) or a short message). The light SSB 205 may be compact in the time-domain. For example, signals of the light SSB 205 may be arranged back to back in time-domain without gaps in-between the signals.

In some examples, the PBCH signal design for on-demand SSB 215 may depend on the SSB index, and the scrambling seed may depend on the PCI and the SSB index. For example, a PBCH DMRS may be derived from at least part of the SSB index (e.g., three LSBs of the SSB index). Two scrambling sequences may be used on a PBCH. The network node 105-a may perform a first scrambling with a first initial seed based on the PCI and SFN (e.g., a subset of bits of the SFN) before CRC and encoding. The network node 105-a may perform a second scrambling with a second initial seed based on PCI and at least part of the SSB index (e.g., three LSBs of the SSB index) after encoding.

In some examples, a full SSB may include a four symbol block. The four symbol block may include the synchronization signal (e.g., PSS or SSS), and PBCH transmitted in the same beam direction. Additionally, or alternatively, a set of SSBs may be confined within a duration (e.g., 5 ms). The set of SSBs may be referred to as a burst set. The burst set may be transmitted based on a defined pattern. For example, SSBs within a burst set may not be tightly packed in time (e.g., two consecutive SSBs may have a temporal gaps in-between the SSBs).

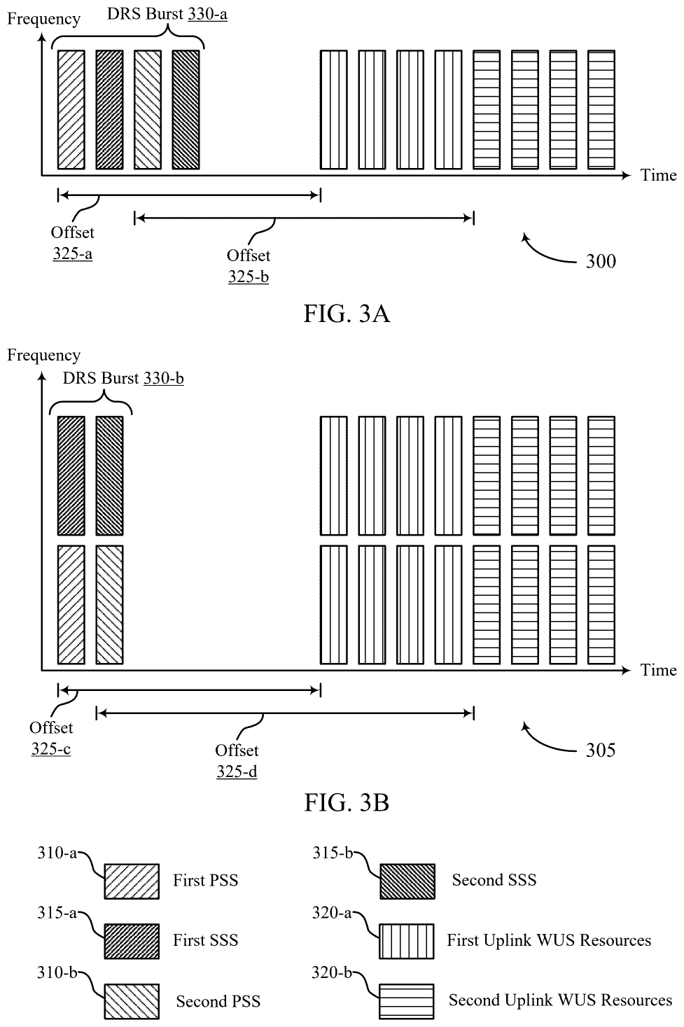

In some cases, the network node 105-a may transmit a discovery reference signal (DRS) (e.g., synchronization signal) and an on-demand PBCH triggered based on an uplink WUS 210. For example, the light SSB 205 may be an example of a DRS or the synchronization signal, and the on-demand SSB 215 may be an example of the on-demand PBCH. In some examples, the network node 105-a may pack DRS (e.g., PSS or SSS) back to back in the time-domain without temporal gaps in-between the synchronization signals, as described with reference to FIG. 3A). In some examples, the network node 105-a may arrange compact PSS and compact SSS (e.g., synchronization signals without temporal gaps) in an FDM manner, as described with reference to FIG. 3B. The network node 105-a may decrease temporal gaps such that after transmitting a DRS burst (e.g., a set of synchronization signals), the network node 105-a may enter a deeper sleep before transmitting the next burst. The deeper sleep may save network energy and decrease power consumption at the network node 105-a.

For compact synchronization signals, the UE 115-a may identify corresponding uplink WUS resources for the UE 115-a to request the on-demand PBCH. In some examples, uplink WUS resources may be a fixed temporal offset from the corresponding compact synchronization signals. For example, the UE 115-a may receive a compact synchronization signal at a first time. The UE 115-a may wait for a time period equal to the fixed temporal offset before transmitting a WUS via uplink WUS resources at a second time. The network node 105-a may identify an SSB corresponding to the synchronization signals based on receiving the WUS 210 at the second time in accordance with the fixed temporal offset.

The fixed temporal offset between a synchronization signal and the uplink WUS burst may be configured. To implement the fixed temporal offset, the synchronization signal and uplink WUS 210 may follow the same packing pattern within the burst. If the same packing pattern is not followed, the synchronization signal and uplink WUS 210 may not utilize the fixed temporal offset based on overlapping uplink WUS resources, which may introduce ambiguity between the uplink WUS resources and the corresponding synchronization signals. In some examples, the uplink WUS 210 may span multiple symbols to account for an uplink and downlink imbalance (e.g., a transmit power difference between the network node 105-a and the UE 115-a). A compact synchronization signal of the DRS burst may span a single symbol. To prevent overlapping WUS resources, there may be a temporal gaps between two consecutive synchronization signals or DRS to match the uplink WUS length (e.g., when the uplink WUS signal length is larger than the synchronization signal length). The temporal gaps prevent compact synchronization signals, increasing power consumption at the network node 105-a.

According to techniques described herein, the UE 115-a may identify uplink WUS resources corresponding to a synchronization signal based on a variable offset. The variable offset may be based on a DRSIdx included in a compact synchronization signal of the light SSB 205 (e.g., a PSS or an SSS). The UE 115-a may transmit the uplink WUS 210 via the identified uplink WUS resources. In response to receiving the WUS 210, the network node 105-a may transmit the on-demand SSB 215 including the on-demand PBCH. In some cases, the on-demand PBCH may include modified information based on the PCI.

For example, a PSS or SSS may carry a virtual cell ID and DRSIdx instead of a PCI. By detecting the PSS or SSS, the UE 115-a may acquire the virtual cell ID and the DRSIdx. The UE 115-a may determine uplink WUS resources based on the DRSIdx. The UE 115-a may determine the full PCI of the active cell based on the on-demand PBCH, the anchor cell, or the virtual cell ID. In some examples, the network node 105-a may FDM the PSS and the SSS, as described with reference to FIG. 3B. The synchronization signal (e.g., PSS or SSS) may be mapped to uplink WUS occasions. In some examples, the communication between the UE 115-a and the network node 105-a may be standalone or overlap with the anchor cell of the network node 105-b.

For example, the variable offset, used to determine a set of WUS resources based on a corresponding received synchronization signal, may be determined in accordance with Equation 1.

$${offset}_{i} = {offset}_{0} + ( DRSIdx - 1 ) \cdot ( WUSLength - PSSSSSLength ) \qquad ( 1 )$$

In this example, the variable offset (offsetᵢ) for a given synchronization signal in a DRS burst (e.g., a set of one or more compact synchronization signal) may be based on an initial offset (offset₀) of a synchronization signal of the DRS burst, the DRSIdx indicated by the given synchronization signal (DRSIdx), a length of the WUS resources (WUSLength), and the length of a synchronization signal (e.g., the compact PSS and the compact SSS) in the DRS burst (PSSSSSLength).

The UE 115-a and the network node 105-a may support compact synchronization signals based on the synchronization signals indicating (e.g., carrying) the DRSIdx. The DRSIdx may indicate a synchronization signal (e.g., an i-th PSS or SSS) within a DRS burst. Additionally, or alternatively, the synchronization signals may include information to differentiate the synchronization signals from other synchronization signals transmitted from neighbor cells to avoid collisions. For example, the UE 115-a and the network node 105-b may utilize a PCI corresponding to a synchronization signal to differentiate PCIs from neighbor cells to avoid PCI collision. For example, the UE 115-a and the network node 105-a may be configured with 1008 values of PCIs.

If a synchronization signal indicates both the PCI and the DRSIdx, then the total quantity of waveforms for a synchronization signal may be relatively large. For example, the total quantity of waveforms may be equivalent to the quantity of PCIs (e.g., 1008) multiplied by the size of the DRSIdx. The waveform detection computation at the UE 115-a may be relatively demanding if a synchronization signal includes (e.g., conveys) both the PCI and the DRSIdx.

The UE 115-a may be able to distinguish a synchronization signal from a synchronization signal of neighboring cells in an area utilizing a subset of PCIs. For example, the synchronization signal may include a virtual cell ID. The virtual cell ID may be shorter than the PCI. The synchronization signals including the virtual cell ID and the DRSIdx may span a same, or slightly larger, quantity of waveforms as synchronization signals including a PCI.

For example, the synchronization signal may indicate a DRSIdx and a virtual cell ID instead of PCI. The UE 115-a may determine associated uplink WUS resources for transmission of the uplink WUS 210 corresponding to a detected synchronization signal based on the DRSIdx. For example, the starting symbol of an uplink WUS 210 may be determined in accordance with Equation 1. The UE 115-a may identify the synchronization signal as being transmitted by the active cell of the network node 105-a based on the virtual cell ID.

The default value for the initial offset (offset₀), the length of the WUS resources (WUSLength), or the length of synchronization signal (PSSSSSLength) may be defined or indicated from an anchor cell of the network node 105-b. For example, the network node 105-b may indicate the initial offset, the length of the WUS resources, or the length of the compact PSS and the compact SSS via control signal 220-a and control signal 220-b.

The UE 115-a may utilize the virtual cell ID to differentiate synchronization signals from different cells in the area (e.g., to minimize or avoid signal collision). The virtual cell ID may be based on the PCI of the active cell. In some examples, the virtual cell ID may indicate an index within a subset of PCIs (e.g., virtualCellID=i may indicate the i-th PCI included in the subset). The subset of PCIs may be indicated by the anchor cell of the network node 105-b for cells overlayed with the anchor cell. In some examples, all supported PCIs may be divided into subgroups, and the virtual cell ID may indicate a subgroup index. In some examples, a PCI may be uniquely mapped to a first partial PCI (n1) and a second partial PCI (n2), and the virtual cell ID may indicate one of the first partial PCI or the second partial PCI. In some examples, the virtual cell ID may indicate a set (n) of least significant bits (LSBs) or most significant bits (MSBs) of the PCI of the active cell.

In some cases, the UE 115-a may determine the PCI of the active cell based on the virtual cell ID and other information indicated by the on-demand PBCH or the anchor cell of the network node 105-b. In some examples, the anchor cell may indicate a subset of PCIs, and the virtual cell ID may indicate an index within the subset of PCIs. The anchor cell may transmit an indication of the subset of PCIs to the UE 115-a via control signal 220-a. In some examples, the UE 115-a may determine the PCI based on the first partial PCI and the second partial PCI. For example, the PCI may be uniquely mapped to the first partial PCI (n1) and the second partial PCI (n2). The virtual cell ID may indicate the first partial PCI, and the on-demand PBCH may indicate the second partial PCI. The UE 115-a may determine the PCI based on the first partial PCI and the second partial PCI. In some examples, the virtual cell ID may indicate a set of LSBs or MSBs of the PCI, and the on-demand PBCH may indicate remaining bits of PCI. In some cases, the UE 115-a may determine the PCI based on the on-demand PBCH alone. For example, the on-demand SSB 215 may indicate the full PCI.

In some examples, the synchronization signals (e.g., the PSS or the SSS) may be multiplexed in the time-domain (e.g., TDM), as described with reference to FIG. 3A. The temporal gaps between the synchronization signals may be defined or indicated by an anchor cell of the network node 105-b via the control signals 220. For compacted synchronization signals, the temporal gaps may be zero. In some examples, the synchronization signals may be multiplexed in the frequency domain (e.g., FDM), as described with reference to FIG. 3B. The frequency offset between the PSS and the SSS may be defined or indicated by the anchor cell via the control signals 220.

Depending on the implementation of the UE 115-a, the UE 115-a may utilize the entire bandwidth (e.g., the entire bandwidth used for the FDM) to capture both the PSS and the SSS for processing, or the UE 115-a may capture the PSS and the SSS in sequence. For example, the UE 115-a may capture the PSS at a PSS bandwidth for PSS detection. The UE 115-a may retune a receiver to an SSS bandwidth for SSS detection, and the UE 115-a may capture the SSS. The UE 115-a may utilize the entire bandwidth or capture the PSS and the SSS in sequence based on a respective power consumption and a respective acquisition latency.

A packing pattern for different SSBs within a burst may be defined or indicated by the anchor cell of the network node 105-b via the control signals 220. For example, a packing pattern may pack synchronization signals back-to-back in the time domain.

Upon detection of a synchronization signal, the UE 115-a may determine the set of resources for uplink WUS based on the DRSIdx, and the UE 115-a may transmit the uplink WUS 210 to request on-demand PBCH. The on-demand PBCH may be a modified on-demand PBCH. For example, the modified on-demand PBCH may include additional information compared to a PBCH included in a full SSB. For example, the modified on-demand SSB may include information enabling the UE 115-a to determine the PCI of the active cell.

The offset of uplink WUS 210 to the associated synchronization signal may be determined based on DRSIdx, as described by Equation 1. The UE 115-a may perform a retransmission of the uplink WUS 210 at a next occasion (e.g., burst-periodicity+offset (DRSIdx)) at an increased power if the UE 115-a does not receive an on-demand PBCH within a response time window. The UE 115-a may stop transmitting uplink WUSs 210 after a threshold quantity of transmissions.

Other parameters of the uplink WUS 210 that are not determined by DRSIdx may be defined or indicated by the anchor cell of the network node 105-b. A transmit power of the uplink WUS 210 may be determined based on a received power from the synchronization signal. A cyclic prefix (CP) of the uplink WUS 210 may be relatively large to cover a cell size of the active cell.

In some cases, the virtual cell ID and the DRSIdx may be mapped to the first NID and the second NID, so that a same set of synchronization signals may be reused for a light SSB 205 and a full SSB. The network node 105-a may utilize the same set of synchronization signals based on a largest virtual cell ID and a largest DRSIdx satisfying a threshold (e.g., (max virtualCellID+1)*(max DRSIdx+1)=1008) and one more than the largest virtual cell ID or one more than the largest DRSIdx being divisible by three (e.g., (max virtualCellID+1) or (max DRSIdx+1) is divisible by 3). In some examples (e.g., if (max DRSIdx+1) is divisible by 3), the first NID may be based on the DRSIdx and the virtual cell ID (e.g., NID1=(max DRSIdx+1)/3*virtualCellID+floor (DRSIdx/3)), and the second NID may be based on the DRSIdx (e.g., NID2=mod (DRSIdx, 3)). In some examples (e.g., if (max virtualCellID+1) is divisible by 3), the first NID may be based on the DRSIdx and the virtual cell ID (e.g., (max virtualCellID+1)/3*DRSIdx+floor (virtualCellID/3)), and the second NID may be based on the virtual cell ID (e.g., N1D2-mod (virtualCellID, 3)). There may be many combinations of the virtual cell ID and the DRSIdx which enable the network node 105-a to utilize the same set of synchronization signals.

In an illustrative example, the largest virtual cell ID may be 20 (e.g., max virtualCellID+1=21), and the largest DRSIdx may be 47 (e.g., max DRSIdx+1=48). The first NID may be determined based on the virtual cell ID and the DRSIdx (e.g., N1D1=16*virtualCellID+floor (DRSIdx/3)), and the second NID may be determined based on the DRSIdx since one more than the largest DRSIdx (48) is divisible by 3 (e.g., NID2=mod (DRSIdx,3)). In some examples, the first NID may be determined based on the DRSIdx and the virtual cell ID (e.g., NID1=7*DRSIdx+floor (virtualCellID/3)), and the second NID may be determined based on the virtual cell ID (e.g., NID2=mod (virtualCellID, 3)).

Additionally, or alternatively, the network node 105-a may provide different values of the virtual cell ID and the DRSIdx to utilize the same set of synchronization signals. In some examples, the largest virtual cell ID may be 11 (e.g., max virtualCellID+1=12), and the largest DRSIdx value may be 83 (e.g., max DRSIdx+1=84). In some examples, the largest virtual cell ID may be 83 (e.g., max virtualCellID+1=84), and the largest DRSIdx may be 11 (e.g., max DRSIdx+1=12). In some examples, the largest virtual cell ID may be 62 (e.g., max virtualCellIdx+1=63), and the largest DRSIdx may be 15 (e.g., max DRSIdx+1=16). In some examples, the largest virtual cell ID may be 251 (e.g., max virtualCellID+1=252), and the largest DRSIdx may be 3 (e.g., max DRSIdx+1=4).

In some cases, synchronization signal generation may be unique for a light SSB 205 and a full SSB. For example, synchronization signal generation for a light SSB 205 may be based on the virtual cell ID and the DRSIdx, where a quantity of waveforms for the light SSB 205 is greater than a quantity of waveforms for the full SSB (e.g., max virtualCellID+1)*(max DRSIdx+1)>1008). The light SSB 205 may utilize a unique synchronization signal generation compared to the full SSB. For example, the quantity of PSSs may be larger than 3, but still be a relatively small quantity (e.g., 4). Additionally, or alternatively, the quantity of SSSs may be larger than 336 (e.g., 336=3*112), but still be a relatively small quantity (e.g., 4*112).

The UE 115-a may transmit a first signal of a set of one or more signals for the uplink WUS 210. For example, a single or multiple signals may be specified for the uplink WUS 210. In some examples, a single signal may be defined for the uplink WUS 210. The single signal be transmitted by multiple UEs 115 to request the on-demand SSB 215 (e.g., modified on-demand PBCH) at the same time. In some examples, multiple signals may be defined for the uplink WUS 210, and the UE 115-a may select one or more signals of the multiple signals for transmitting the uplink WUS 210 based on detection of the light SSB 205 (e.g., synchronization signal). The multiple signals may be PRACH signals with different preamble IDs. In some examples, the UE 115-a may select the one or more signals out of the multiple defined signals randomly. In some examples, the UE 115-a may select the one or more signals out of the multiple signals to indicate configuration information to the network node 105-a.

For example, via the one or more selected signals, the UE 115-a may indicate desired parameters for the modified on-demand PBCH from a set of candidate values. The UE 115-a may indicate a time or frequency resource, a quantity of transmissions, or a transmission duration for the modified on-demand PBCH. Additionally, or alternatively, the UE 115-a may indicate, via the one or more selected signals, a mobility states or a class of the UE 115-a (e.g., eMBB, redcap, IOT).

In accordance with the reception of the uplink WUS 210, the network node 105-a may transmit the modified on-demand PBCH using one or more transmit beams, and at least one of the transmit beams may be QCL with the synchronization signal associated with the received uplink WUS. In some examples, the network node 105-a may transmit the on-demand SSB 215 via a transmit beam QCL with the synchronization signal corresponding to the received uplink WUS 210. In some examples, the network node 105-a may transmit a beam-swept modified on-demand PBCH using multiple neighbor beams, where at least one of the neighbor beams may be QCL with the synchronization signal associated with uplink WUS 210.

The network node may transmit the modified on-demand PBCH in accordance with a set of parameters. In some examples, the set of parameters (e.g., time or frequency resource, the quantity of transmissions, or the transmission duration) or a set of candidate parameters for the modified on-demand PBCH may be defined or indicated by the anchor cell of the network node 105-b. In some examples, the network node 105-a may select values for the set of parameters based on the received uplink WUS 210. For example, the WUS 210 may indicate parameters for the modified on-demand PBCH. Additionally, or alternatively, the uplink WUS 210 may indicate mobility states or classes of the UE 115-a, and the network node 105-a may select the set of parameters in accordance with the mobility states or the classes of the UE 115-a.

The modified on-demand PBCH may indicate the PCI of the cell, the partial PCI so that the PCI of the cell may be identified using the partial PCI and the virtual cell ID (e.g., virtual cell ID may be a set of MSB or LSB of the PCI, and the partial PCI may be the remaining LSB or MSB of the PCI). Additionally, or alternatively, the modified on-demand PBCH may indicate a MIB. The modified on-demand PBCH may include the same PBCH physical payload as a full SSB except for an SSB index. For example, the modified on-demand PBCH may include four LSBs of a SFN or a half frame index. Additionally, or alternatively, the on-demand SSB 215 may indicate a quantity of transmitted modified on-demand PBCHs, time-duration of the modified on-demand PBCH, or a quantity of transmit beams for a beam-swept modified on-demand PBCH.

The network node 105-a may utilize PBCH demodulation reference signals (DMRS) and scrambling seeds based on the virtual cell ID and the DRSIdx. The network node 105-a may replace the SSB index with the DRSIdx whenever the SSB index is used in DMRS and scrambling sequence generation. Additionally, or alternatively, the network node 105-a may replace the PCI with the virtual cell ID whenever the PCI is used for scrambling sequence generation.

FIG. 3A shows an example of a communications timeline 300 that supports synchronization signal design for network energy savings in accordance with one or more aspects of the present disclosure. In some examples, the communications timeline 300 may implement aspects of wireless communications system 100 and wireless communications system 200. For example, the communications timeline 300 may be implemented by a UE 115 and a network node 105 as described with reference to FIGS. 1 and 2.

A DRS burst 330-a may include synchronization signals (e.g., a first PSS 310-a, a first SSS 315-a, a second PSS 310-b, and a second SSS 315-b) multiplexed in the time-domain (e.g., TDM). In some examples, a UE 115 may receive the first PSS 310-a and the first SSS 315-a sequentially. The UE 115 may determine a first variable offset 325-a in accordance with Equation 1. The UE 115 may wait until the expiration of the variable offset before transmitting a WUS via the first uplink WUS resources 320-a. The network node 105-a may receive the WUS via the first uplink WUS resources 320-a, and the network node 105-a may identify the first PSS 310-a and the first SSS 315-a based on receiving the WUS via the first uplink WUS resources 320-a. In some examples, the UE 115 may receive the second PSS 310-b and the second SSS 315-b sequentially. The UE 115 may determine a second variable offset 325-b in accordance with Equation 1. The second variable offset 325-b may be longer than the first variable offset 325-a based on a first DRSIdx associated with the first PSS 310-a and the first SSS 315-a and a second DRSIdx associated with the second PSS 310-b and the second SSS 315-b. The first variable offset 325-a and the second variable offset 325-b may prevent overlap between the first uplink WUS resources 320-a and the second uplink WUS resources 320-b.

FIG. 3B shows an example of a communications timeline 305 that supports synchronization signal design for network energy savings in accordance with one or more aspects of the present disclosure. In some examples, the communications timeline 300 may implement aspects of wireless communications system 100, wireless communications system 200, or the communications timeline 300. For example, the communications timeline 305 may be implemented by a UE 115 and a network node 105 as described with reference to FIGS. 1-3A.

A DRS burst 330-b may include synchronization signals (e.g., a first PSS 310-a, a first SSS 315-a, a second PSS 310-b, and a second SSS 315-b) multiplexed in the frequency-domain (e.g., FDM). In some examples, a UE 115 may receive the first PSS 310-a and the first SSS 315-a at the same time. The UE 115 may determine a first variable offset 325-c in accordance with Equation 1. The UE 115 may wait until the expiration of the variable offset before transmitting a WUS via the first uplink WUS resources 320-a. The network node 105-a may receive the WUS via the first uplink WUS resources 320-a, and the network node 105-a may identify the first PSS 310-a and the first SSS 315-a based on receiving the WUS via the first uplink WUS resources 320-a. In some examples, the UE 115 may receive the second PSS 310-b and the second SSS 315-b at the same time. The UE 115 may determine a second variable offset 325-d in accordance with Equation 1. The second variable offset 325-d may be longer than the first variable offset 325-c based on a first DRSIdx associated with the first PSS 310-a and the first SSS 315-a and a second DRSIdx associated with the second PSS 310-b and the second SSS 315-b.

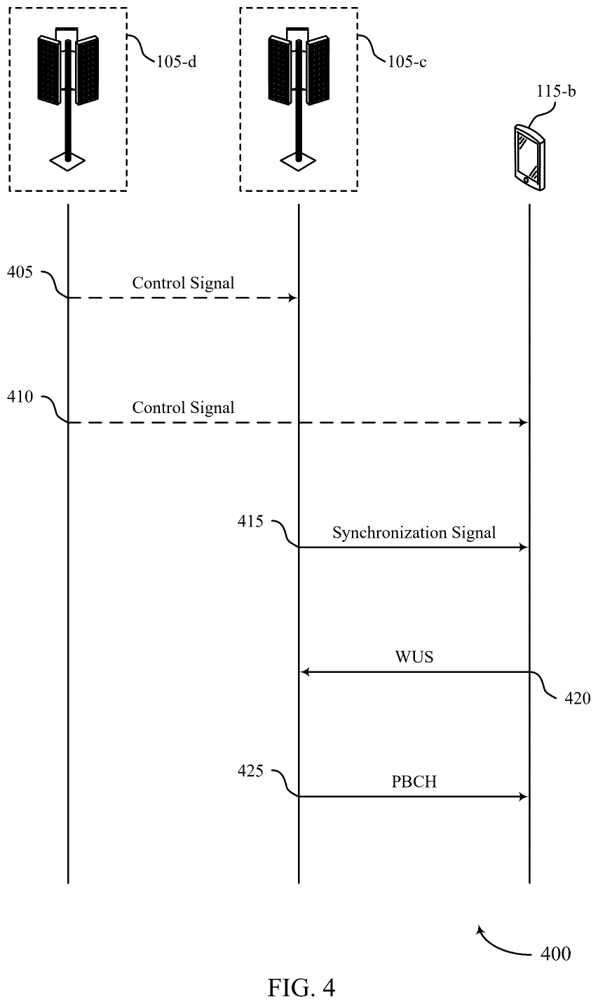

FIG. 4 shows an example of a process flow 400 that supports synchronization signal design for network energy savings in accordance with one or more aspects of the present disclosure. In some examples, process flow 400 may implement aspects of, or be implemented by aspects of, the wireless communications system 100, the wireless communications system 200, the communications timeline 300, or the communications timeline 305. For example, the process flow 400 may include a UE 115-b, a network node 105-c, and a network node 105-d which may be examples of corresponding devices described with reference to FIGS. 1-3. In some cases, the network node 105-c and the network node 105-d may be the same network node 105.

In some cases, at 405, the network node 105-c may obtain a control signal (e.g., the control signal 220-b as described with reference to FIG. 2) from an anchor cell of the network node 105-d. The network node 105-c may obtain, from the anchor cell of the network node 105-d, a set of PCIs corresponding to one or more cells associated with the anchor cell. In some cases, the network node 105-c may obtain, from the anchor cell, an indication of an offset, an uplink WUS length, and a synchronization signal length. The resources of the cell may be based on the offset, the uplink WUS length, and the synchronization signal length. In some cases, the network node 105-c may obtain, from the anchor cell, an indication of the time gap, the frequency offset, or both. In some cases, the network node 105-c may obtain, from the anchor cell, an indication of a packing pattern associated with the burst of synchronization signals. The network node 105-c may output a synchronization signal for the cell based on the packing pattern.

In some cases, at 410, the UE 115-b may receive a control signal (e.g., the control signal 220-a as described with reference to FIG. 2) from the anchor cell of the network node 105-d. The UE 115-b may receive, from the anchor cell, a set of PCIs corresponding to one or more cells associated with the anchor cell. In some cases, the UE 115-a may receive, from the anchor cell, an indication of an offset, an uplink WUS length, or a synchronization signal length. The resources of the cell may be based on the offset, the uplink WUS length, or the synchronization signal length. In some cases, the UE 115-a may receive, from the anchor cell, an indication of the time gap, the frequency offset, or both. In some cases, the UE 115-a may receive, from the anchor cell, an indication of a packing pattern associated with the burst of synchronization signals. The UE 115-a may receive the synchronization signal for the cell based on the packing pattern.

At 415, the UE 115-b may receive the synchronization signal (e.g., the light SSB 205 as described with reference to FIG. 2) for a cell. The synchronization signal may include a DRSIdx corresponding to an index of the synchronization signal within a burst of synchronization signals. In some cases, the burst of synchronization signals may be TDMed based on a time gap, FDMed based at least in part on a frequency offset, or both.

In some cases, the UE 115-b may receive, via the synchronization signal for the cell, a virtual cell ID of the cell, wherein the virtual cell ID is associated with a PCI of the cell. In some examples, the PCI may be mapped to a first NID and a second NID, and the virtual cell ID may include the first NID or the second NID. In some examples, the PBCH may include a partial PCI, and the PCI may be determined based on the partial PCI and the virtual cell ID. In some examples, the virtual cell ID may correspond to a set of MSBs of the PCI or a set of LSBs of the PCI. In some examples, the virtual cell ID may include a second index, and the second index may indicate the PCI in the set of PCIs. In some examples, the set of PCIs may correspond to the one or more cells may be divided into multiple subgroups. The virtual cell ID may indicate a subgroup associated with the PCI.

In some cases, the virtual cell ID and the DRSIdx may be mapped to a first NID and a second NID associated with the synchronization signal. In some cases, a sequence associated with the synchronization signal may be based on the virtual cell ID and the DRSIdx.

At 420, the UE 115-b may transmit a WUS (e.g., the uplink WUS 210 as described with reference to FIG. 2) via resources of the cell that are determined based on the DRSIdx. In some cases, the WUS may include a single signal. In some cases, the WUS may include a set of signals. In some cases, the WUS may include an indication of a mobility state at the UE.

In some cases, the UE 115-b may transmit a second WUS via second resources of the cell that are determined based on the DRSIdx. A transmit power associated with the second WUS may be based on the second WUS being a retransmission of the WUS.

At 425, the UE 115-b may receive a PBCH (e.g., the on-demand SSB 215 as described with reference to FIG. 2) of the cell based on transmitting the WUS. In some cases, data associated with the PBCH may be based on the WUS. In some cases, a DMRS scrambling seed associated with the PBCH may be based on the virtual cell ID or the DRSIdx. In some cases, the PBCH may include a PCI.

In some cases, the UE 115-a may receive the PBCH via one or more transmit beams at a network node 105-c associated with the cell. At least one of the one or more transmit beams may be QCL with the synchronization signal.

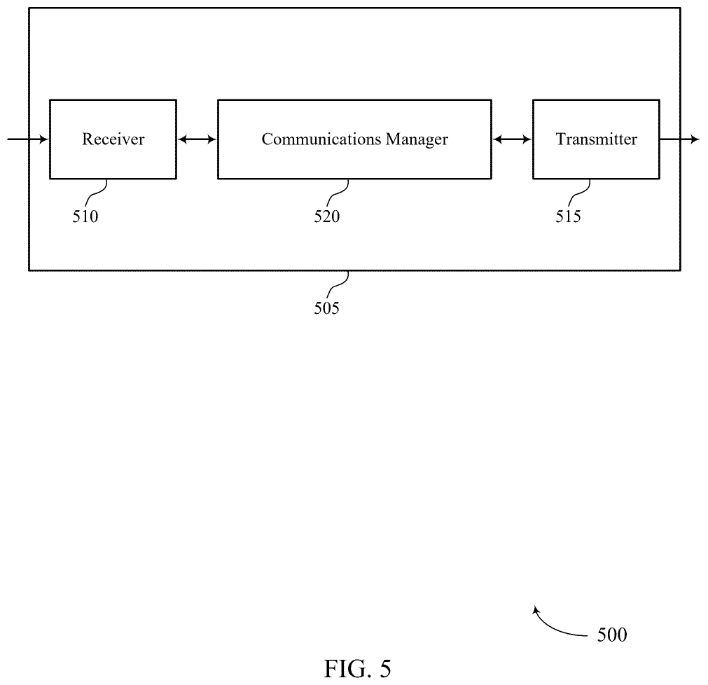

FIG. 5 shows a block diagram 500 of a device 505 that supports synchronization signal design for network energy savings in accordance with one or more aspects of the present disclosure. The device 505 may be an example of aspects of a UE 115 as described herein. The device 505 may include a receiver 510, a transmitter 515, and a communications manager 520. The device 505, or one or more components of the device 505 (e.g., the receiver 510, the transmitter 515, the communications manager 520), may include one or more processors, memory coupled with the one or more processors, and instructions stored in the memory that are executable by the one or more processors to enable the one or more processors to support synchronization signal design for network energy savings features discussed herein. Each of these components may be in communication with one another (e.g., via one or more buses).

The receiver 510 may provide a means for receiving information such as packets, user data, control information, or any combination thereof associated with various information channels (e.g., control channels, data channels, information channels related to synchronization signal design for network energy savings). Information may be passed on to other components of the device 505. The receiver 510 may utilize a single antenna or a set of multiple antennas.

The transmitter 515 may provide a means for transmitting signals generated by other components of the device 505. For example, the transmitter 515 may transmit information such as packets, user data, control information, or any combination thereof associated with various information channels (e.g., control channels, data channels, information channels related to synchronization signal design for network energy savings). In some examples, the transmitter 515 may be co-located with a receiver 510 in a transceiver module. The transmitter 515 may utilize a single antenna or a set of multiple antennas.

The communications manager 520, the receiver 510, the transmitter 515, or various combinations or components thereof may be examples of means for performing various aspects of synchronization signal design for network energy savings as described herein. For example, the communications manager 520, the receiver 510, the transmitter 515, or various combinations or components thereof may be capable of performing one or more of the functions described herein.

In some examples, the communications manager 520, the receiver 510, the transmitter 515, or various combinations or components thereof may be implemented in hardware (e.g., in communications management circuitry). The hardware may include at least one of a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 520, the receiver 510, the transmitter 515, or various combinations or components thereof may be implemented in code (e.g., as communications management software or firmware) executed by at least one processor (e.g., referred to as a processor-executable code). If implemented in code executed by at least one processor, the functions of the communications manager 520, the receiver 510, the transmitter 515, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 520 may be configured to perform various operations (e.g., receiving, obtaining, monitoring, outputting, transmitting) using or otherwise in cooperation with the receiver 510, the transmitter 515, or both. For example, the communications manager 520 may receive information from the receiver 510, send information to the transmitter 515, or be integrated in combination with the receiver 510, the transmitter 515, or both to obtain information, output information, or perform various other operations as described herein.

The communications manager 520 may support wireless communications in accordance with examples as disclosed herein. For example, the communications manager 520 is capable of, configured to, or operable to support a means for receiving a synchronization signal for a cell, where the synchronization signal includes a DRSIdx corresponding to an index of the synchronization signal within a burst of synchronization signals. The communications manager 520 is capable of, configured to, or operable to support a means for transmitting a WUS via resources of the cell that are determined based on the DRSIdx. The communications manager 520 is capable of, configured to, or operable to support a means for receiving a PBCH of the cell based on transmitting the WUS.

By including or configuring the communications manager 520 in accordance with examples as described herein, the device 505 (e.g., at least one processor controlling or otherwise coupled with the receiver 510, the transmitter 515, the communications manager 520, or a combination thereof) may support techniques for reduced power consumption, more efficient utilization of communication resources, and the like.

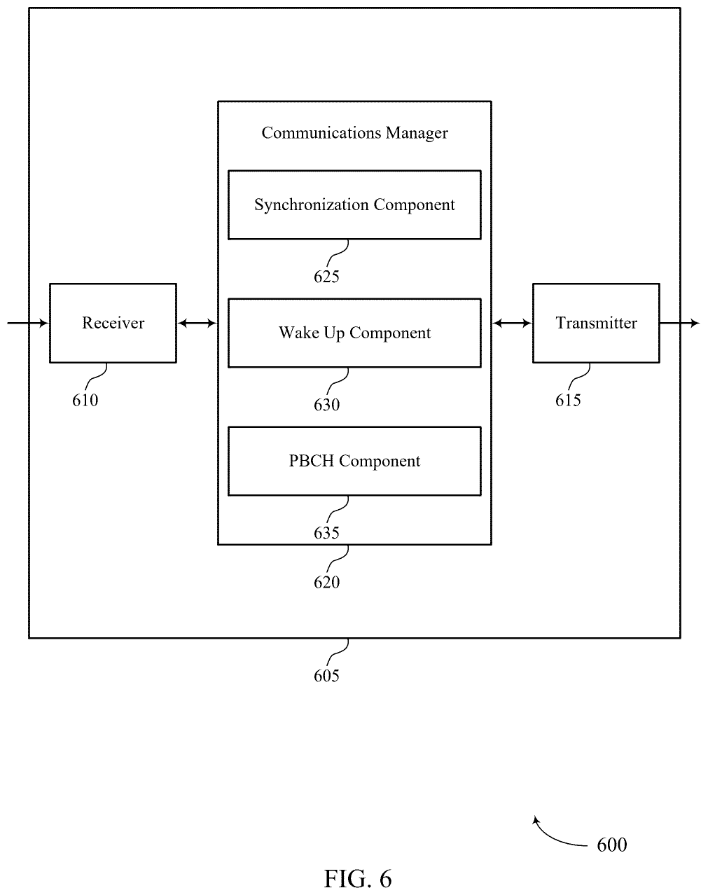

FIG. 6 shows a block diagram 600 of a device 605 that supports synchronization signal design for network energy savings in accordance with one or more aspects of the present disclosure. The device 605 may be an example of aspects of a device 505 or a UE 115 as described herein. The device 605 may include a receiver 610, a transmitter 615, and a communications manager 620. The device 605, or one or more components of the device 605 (e.g., the receiver 610, the transmitter 615, the communications manager 620), may include at least one processor, which may be coupled with at least one memory, to support the described techniques. Each of these components may be in communication with one another (e.g., via one or more buses).

The receiver 610 may provide a means for receiving information such as packets, user data, control information, or any combination thereof associated with various information channels (e.g., control channels, data channels, information channels related to synchronization signal design for network energy savings). Information may be passed on to other components of the device 605. The receiver 610 may utilize a single antenna or a set of multiple antennas.

The transmitter 615 may provide a means for transmitting signals generated by other components of the device 605. For example, the transmitter 615 may transmit information such as packets, user data, control information, or any combination thereof associated with various information channels (e.g., control channels, data channels, information channels related to synchronization signal design for network energy savings). In some examples, the transmitter 615 may be co-located with a receiver 610 in a transceiver module. The transmitter 615 may utilize a single antenna or a set of multiple antennas.

The device 605, or various components thereof, may be an example of means for performing various aspects of synchronization signal design for network energy savings as described herein. For example, the communications manager 620 may include a synchronization component 625, a wake up component 630, a PBCH component 635, or any combination thereof. The communications manager 620 may be an example of aspects of a communications manager 520 as described herein. In some examples, the communications manager 620, or various components thereof, may be configured to perform various operations (e.g., receiving, obtaining, monitoring, outputting, transmitting) using or otherwise in cooperation with the receiver 610, the transmitter 615, or both. For example, the communications manager 620 may receive information from the receiver 610, send information to the transmitter 615, or be integrated in combination with the receiver 610, the transmitter 615, or both to obtain information, output information, or perform various other operations as described herein.

The communications manager 620 may support wireless communications in accordance with examples as disclosed herein. The synchronization component 625 is capable of, configured to, or operable to support a means for receiving a synchronization signal for a cell, where the synchronization signal includes a DRSIdx corresponding to an index of the synchronization signal within a burst of synchronization signals. The wake up component 630 is capable of, configured to, or operable to support a means for transmitting a WUS via resources of the cell that are determined based on the DRSIdx. The PBCH component 635 is capable of, configured to, or operable to support a means for receiving a PBCH of the cell based on transmitting the WUS.

In some cases, the synchronization component 625, the wake up component 630, or the PBCH component 635 may each be or be at least a part of a processor (e.g., a transceiver processor, or a radio processor, or a transmitter processor, or a receiver processor). The processor may be coupled with memory and execute instructions stored in the memory that enable the processor to perform or facilitate the features of the synchronization component 625, the wake up component 630, or the PBCH component 635 discussed herein. A transceiver processor may be collocated with and/or communicate with (e.g., direct the operations of) a transceiver of the device. A radio processor may be collocated with and/or communicate with (e.g., direct the operations of) a radio (e.g., an NR radio, an LTE radio, a Wi-Fi radio) of the device. A transmitter processor may be collocated with and/or communicate with (e.g., direct the operations of) a transmitter of the device. A receiver processor may be collocated with and/or communicate with (e.g., direct the operations of) a receiver of the device.

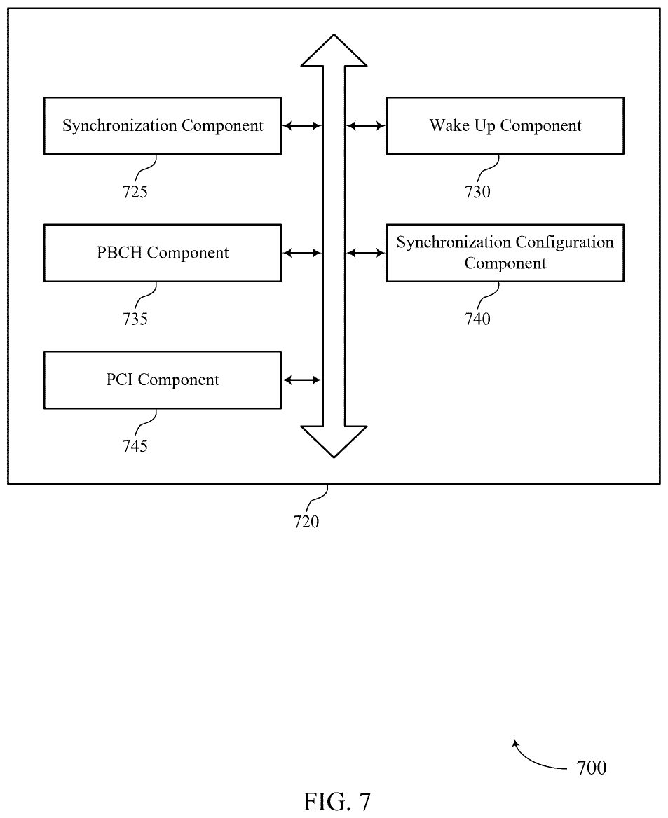

FIG. 7 shows a block diagram 700 of a communications manager 720 that supports synchronization signal design for network energy savings in accordance with one or more aspects of the present disclosure. The communications manager 720 may be an example of aspects of a communications manager 520, a communications manager 620, or both, as described herein. The communications manager 720, or various components thereof, may be an example of means for performing various aspects of synchronization signal design for network energy savings as described herein. For example, the communications manager 720 may include a synchronization component 725, a wake up component 730, a PBCH component 735, a synchronization configuration component 740, a PCI component 745, or any combination thereof. Each of these components, or components or subcomponents thereof (e.g., one or more processors, one or more memories), may communicate, directly or indirectly, with one another (e.g., via one or more buses).

The communications manager 720 may support wireless communications in accordance with examples as disclosed herein. The synchronization component 725 is capable of, configured to, or operable to support a means for receiving a synchronization signal for a cell, where the synchronization signal includes a DRSIdx corresponding to an index of the synchronization signal within a burst of synchronization signals. The wake up component 730 is capable of, configured to, or operable to support a means for transmitting a WUS via resources of the cell that are determined based on the DRSIdx. The PBCH component 735 is capable of, configured to, or operable to support a means for receiving a PBCH of the cell based on transmitting the WUS.

In some examples, the synchronization component 725 is capable of, configured to, or operable to support a means for receiving, via the synchronization signal for the cell, a virtual cell identifier of the cell, where the virtual cell identifier is associated with a PCI of the cell.

In some examples, the PBCH includes a partial PCI. In some examples, the PCI is determined based on the partial PCI and the virtual cell identifier.

In some examples, the PCI component 745 is capable of, configured to, or operable to support a means for receiving, from an anchor cell, a set of PCIs corresponding to one or more cells associated with the anchor cell.

In some examples, the virtual cell identifier includes a second index, and the second index indicates the PCI in the set of PCIs.

In some examples, the set of PCIs corresponding to the one or more cells are divided into a set of multiple subgroups. In some examples, the virtual cell identifier indicates a subgroup associated with the PCI.

In some examples, the PCI is mapped to a first network identifier and a second network identifier, and the virtual cell identifier includes the first network identifier or the second network identifier.

In some examples, the virtual cell identifier corresponds to a set of most significant bits of the PCI or a set of least significant bits of the PCI.

In some examples, a sequence associated with the synchronization signal is based on the virtual cell identifier and the DRSIdx.

In some examples, the virtual cell identifier and the DRSIdx are mapped to a first network identifier and a second network identifier associated with the synchronization signal.

In some examples, a demodulation reference signal scrambling seed associated with the PBCH is based on the virtual cell identifier or the DRSIdx.

In some examples, the PBCH includes a PCI.

In some examples, the synchronization configuration component 740 is capable of, configured to, or operable to support a means for receiving, from an anchor cell, an indication of an offset, an uplink WUS length, and a synchronization signal length, where the resources of the cell are based on the offset, the uplink WUS length, and the synchronization signal length.

In some examples, the burst of synchronization signals are time division multiplexed based on a time gap, frequency division multiplexed based on a frequency offset, or both.

In some examples, the synchronization configuration component 740 is capable of, configured to, or operable to support a means for receiving, from an anchor cell, an indication of the time gap, the frequency offset, or both.

In some examples, the synchronization configuration component 740 is capable of, configured to, or operable to support a means for receiving, from an anchor cell, an indication of a packing pattern associated with the burst of synchronization signals, where receiving the synchronization signal for the cell is based on the packing pattern.

In some examples, the wake up component 730 is capable of, configured to, or operable to support a means for transmit a second WUS via second resources of the cell that are determined based on the DRSIdx, where a transmit power associated with the second WUS is based on the second WUS being a retransmission of the WUS.

In some examples, the WUS includes a single signal.

In some examples, the WUS includes a set of multiple signals.

In some examples, data associated with the PBCH is based on the WUS.

In some examples, the WUS includes an indication of a mobility state at the UE.

In some examples, to support receiving the PBCH, the PBCH component 735 is capable of, configured to, or operable to support a means for receiving the PBCH via one or more transmit beams at a network node associated with the cell, where at least one of the one or more transmit beams are QCL with the synchronization signal.

In some cases, the synchronization component 725, the wake up component 730, the PBCH component 735, the synchronization configuration component 740, or the PCI component 745 may each be or be at least a part of a processor (e.g., a transceiver processor, or a radio processor, or a transmitter processor, or a receiver processor). The processor may be coupled with memory and execute instructions stored in the memory that enable the processor to perform or facilitate the features of the synchronization component 725, the wake up component 730, the PBCH component 735, the synchronization configuration component 740, or the PCI component 745 discussed herein.

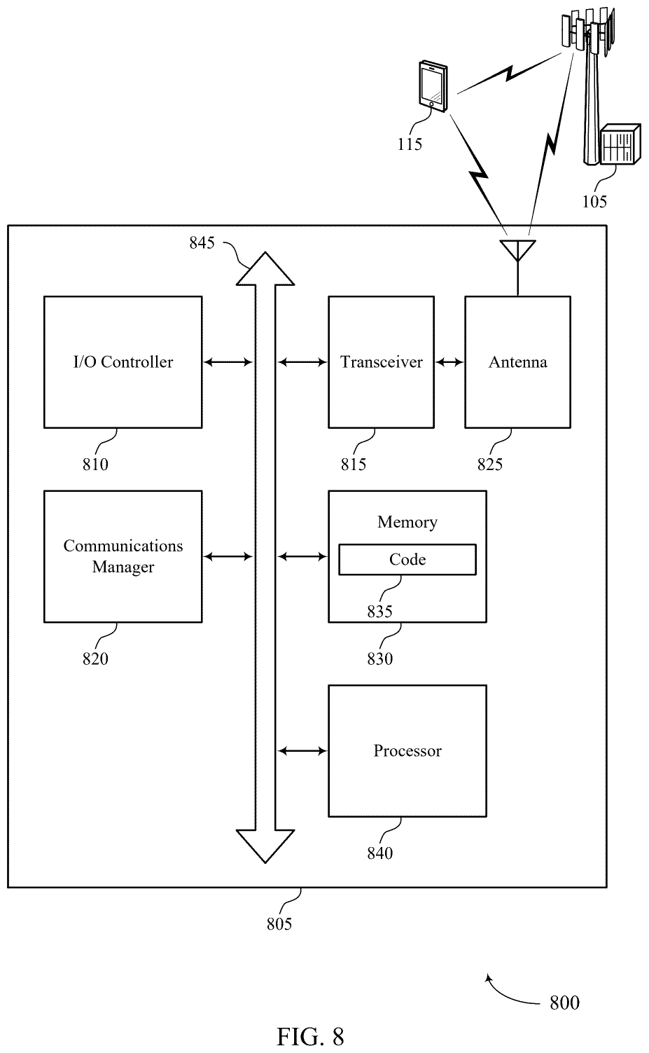

FIG. 8 shows a diagram of a system 800 including a device 805 that supports synchronization signal design for network energy savings in accordance with one or more aspects of the present disclosure. The device 805 may be an example of or include components of a device 505, a device 605, or a UE 115 as described herein. The device 805 may communicate (e.g., wirelessly) with one or more other devices (e.g., network nodes 105, UEs 115, or a combination thereof). The device 805 may include components for bi-directional voice and data communications including components for transmitting and receiving communications, such as a communications manager 820, an input/output (I/O) controller, such as an I/O controller 810, a transceiver 815, one or more antennas 825, at least one memory 830, code 835, and at least one processor 840. These components may be in electronic communication or otherwise coupled (e.g., operatively, communicatively, functionally, electronically, electrically) via one or more buses (e.g., a bus 845).

The I/O controller 810 may manage input and output signals for the device 805. The I/O controller 810 may also manage peripherals not integrated into the device 805. In some cases, the I/O controller 810 may represent a physical connection or port to an external peripheral. In some cases, the I/O controller 810 may utilize an operating system such as iOS®, ANDROID®, MS-DOS®, MS-WINDOWS®, OS/2®, UNIX®, LINUX®, or another known operating system. Additionally, or alternatively, the I/O controller 810 may represent or interact with a modem, a keyboard, a mouse, a touchscreen, or a similar device. In some cases, the I/O controller 810 may be implemented as part of one or more processors, such as the at least one processor 840. In some cases, a user may interact with the device 805 via the I/O controller 810 or via hardware components controlled by the I/O controller 810.

In some cases, the device 805 may include a single antenna. However, in some other cases, the device 805 may have more than one antenna, which may be capable of concurrently transmitting or receiving multiple wireless transmissions. The transceiver 815 may communicate bi-directionally via the one or more antennas 825 using wired or wireless links as described herein. For example, the transceiver 815 may represent a wireless transceiver and may communicate bi-directionally with another wireless transceiver. The transceiver 815 may also include a modem to modulate the packets, to provide the modulated packets to one or more antennas 825 for transmission, and to demodulate packets received from the one or more antennas 825. The transceiver 815, or the transceiver 815 and one or more antennas 825, may be an example of a transmitter 515, a transmitter 615, a receiver 510, a receiver 610, or any combination thereof or component thereof, as described herein.

The at least one memory 830 may include random access memory (RAM) and read-only memory (ROM). The at least one memory 830 may store computer-readable, computer-executable, or processor-executable code, such as the code 835. The code 835 may include instructions that, when executed by the at least one processor 840, cause the device 805 to perform various functions described herein. The code 835 may be stored in a non-transitory computer-readable medium such as system memory or another type of memory. In some cases, the code 835 may not be directly executable by the at least one processor 840 but may cause a computer (e.g., when compiled and executed) to perform functions described herein. In some cases, the at least one memory 830 may include, among other things, a basic I/O system (BIOS) which may control basic hardware or software operation such as the interaction with peripheral components or devices.

The at least one processor 840 may include one or more intelligent hardware devices (e.g., one or more general-purpose processors, one or more DSPs, one or more CPUs, one or more graphics processing units (GPUs), one or more neural processing units (NPUs) (also referred to as neural network processors or deep learning processors (DLPs)), one or more microcontrollers, one or more ASICs, one or more FPGAs, one or more programmable logic devices, discrete gate or transistor logic, one or more discrete hardware components, or any combination thereof). In some cases, the at least one processor 840 may be configured to operate a memory array using a memory controller. In some other cases, a memory controller may be integrated into the at least one processor 840. The at least one processor 840 may be configured to execute computer-readable instructions stored in a memory (e.g., the at least one memory 830) to cause the device 805 to perform various functions (e.g., functions or tasks supporting synchronization signal design for network energy savings). For example, the device 805 or a component of the device 805 may include at least one processor 840 and at least one memory 830 coupled with or to the at least one processor 840, the at least one processor 840 and the at least one memory 830 configured to perform various functions described herein.

In some examples, the at least one processor 840 may include multiple processors and the at least one memory 830 may include multiple memories. One or more of the multiple processors may be coupled with one or more of the multiple memories, which may, individually or collectively, be configured to perform various functions described herein. In some examples, the at least one processor 840 may be a component of a processing system, which may refer to a system (such as a series) of machines, circuitry (including, for example, one or both of processor circuitry (which may include the at least one processor 840) and memory circuitry (which may include the at least one memory 830)), or components, that receives or obtains inputs and processes the inputs to produce, generate, or obtain a set of outputs. The processing system may be configured to perform one or more of the functions described herein. For example, the at least one processor 840 or a processing system including the at least one processor 840 may be configured to, configurable to, or operable to cause the device 805 to perform one or more of the functions described herein. Further, as described herein, being “configured to,” being “configurable to,” and being “operable to” may be used interchangeably and may be associated with a capability, when executing code 835 (e.g., processor-executable code) stored in the at least one memory 830 or otherwise, to perform one or more of the functions described herein.

The communications manager 820 may support wireless communications in accordance with examples as disclosed herein. For example, the communications manager 820 is capable of, configured to, or operable to support a means for receiving a synchronization signal for a cell, where the synchronization signal includes a DRSIdx corresponding to an index of the synchronization signal within a burst of synchronization signals. The communications manager 820 is capable of, configured to, or operable to support a means for transmitting a WUS via resources of the cell that are determined based on the DRSIdx. The communications manager 820 is capable of, configured to, or operable to support a means for receiving a PBCH of the cell based on transmitting the WUS.

By including or configuring the communications manager 820 in accordance with examples as described herein, the device 805 may support techniques for reduced power consumption, more efficient utilization of communication resources, improved coordination between devices, and the like.

In some examples, the communications manager 820 may be configured to perform various operations (e.g., receiving, monitoring, transmitting) using or otherwise in cooperation with the transceiver 815, the one or more antennas 825, or any combination thereof. Although the communications manager 820 is illustrated as a separate component, in some examples, one or more functions described with reference to the communications manager 820 may be supported by or performed by the at least one processor 840, the at least one memory 830, the code 835, or any combination thereof. For example, the code 835 may include instructions executable by the at least one processor 840 to cause the device 805 to perform various aspects of synchronization signal design for network energy savings as described herein, or the at least one processor 840 and the at least one memory 830 may be otherwise configured to, individually or collectively, perform or support such operations.

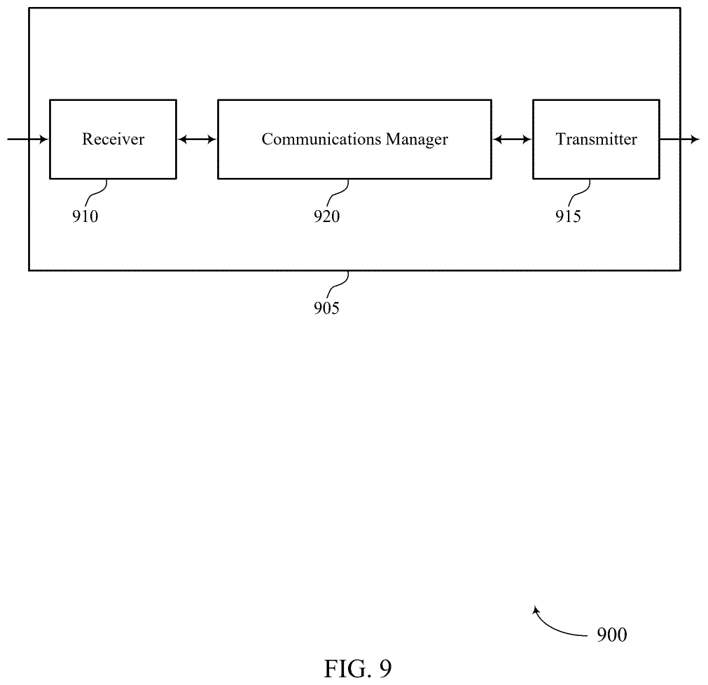

FIG. 9 shows a block diagram 900 of a device 905 that supports synchronization signal design for network energy savings in accordance with one or more aspects of the present disclosure. The device 905 may be an example of aspects of a network node as described herein. The device 905 may include a receiver 910, a transmitter 915, and a communications manager 920. The device 905, or one or more components of the device 905 (e.g., the receiver 910, the transmitter 915, the communications manager 920), may include at least one processor, which may be coupled with at least one memory, to, individually or collectively, support or enable the described techniques. Each of these components may be in communication with one another (e.g., via one or more buses).

The receiver 910 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 905. In some examples, the receiver 910 may support obtaining information by receiving signals via one or more antennas. Additionally, or alternatively, the receiver 910 may support obtaining information by receiving signals via one or more wired (e.g., electrical, fiber optic) interfaces, wireless interfaces, or any combination thereof.

The transmitter 915 may provide a means for outputting (e.g., transmitting, providing, conveying, sending) information generated by other components of the device 905. For example, the transmitter 915 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 915 may support outputting information by transmitting signals via one or more antennas. Additionally, or alternatively, the transmitter 915 may support outputting information by transmitting signals via one or more wired (e.g., electrical, fiber optic) interfaces, wireless interfaces, or any combination thereof. In some examples, the transmitter 915 and the receiver 910 may be co-located in a transceiver, which may include or be coupled with a modem.

The communications manager 920, the receiver 910, the transmitter 915, or various combinations or components thereof may be examples of means for performing various aspects of synchronization signal design for network energy savings as described herein. For example, the communications manager 920, the receiver 910, the transmitter 915, or various combinations or components thereof may be capable of performing one or more of the functions described herein.

In some examples, the communications manager 920, the receiver 910, the transmitter 915, or various combinations or components thereof may be implemented in hardware (e.g., in communications management circuitry). The hardware may include at least one of a processor, a DSP, a CPU, an ASIC, an FPGA or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 920, the receiver 910, the transmitter 915, or various combinations or components thereof may be implemented in code (e.g., as communications management software or firmware) executed by at least one processor (e.g., referred to as a processor-executable code). If implemented in code executed by at least one processor, the functions of the communications manager 920, the receiver 910, the transmitter 915, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 920 may be configured to perform various operations (e.g., receiving, obtaining, monitoring, outputting, transmitting) using or otherwise in cooperation with the receiver 910, the transmitter 915, or both. For example, the communications manager 920 may receive information from the receiver 910, send information to the transmitter 915, or be integrated in combination with the receiver 910, the transmitter 915, or both to obtain information, output information, or perform various other operations as described herein.

The communications manager 920 may support wireless communications in accordance with examples as disclosed herein. For example, the communications manager 920 is capable of, configured to, or operable to support a means for outputting a synchronization signal for a cell, where the synchronization signal includes a DRSIdx corresponding to an index of the synchronization signal within a burst of synchronization signals. The communications manager 920 is capable of, configured to, or operable to support a means for obtaining a WUS via resources of the cell that are determined based on the DRSIdx. The communications manager 920 is capable of, configured to, or operable to support a means for outputting a PBCH of the cell based on obtaining the WUS.

By including or configuring the communications manager 920 in accordance with examples as described herein, the device 905 (e.g., at least one processor controlling or otherwise coupled with the receiver 910, the transmitter 915, the communications manager 920, or a combination thereof) may support techniques for reduced power consumption, more efficient utilization of communication resources, and the like.

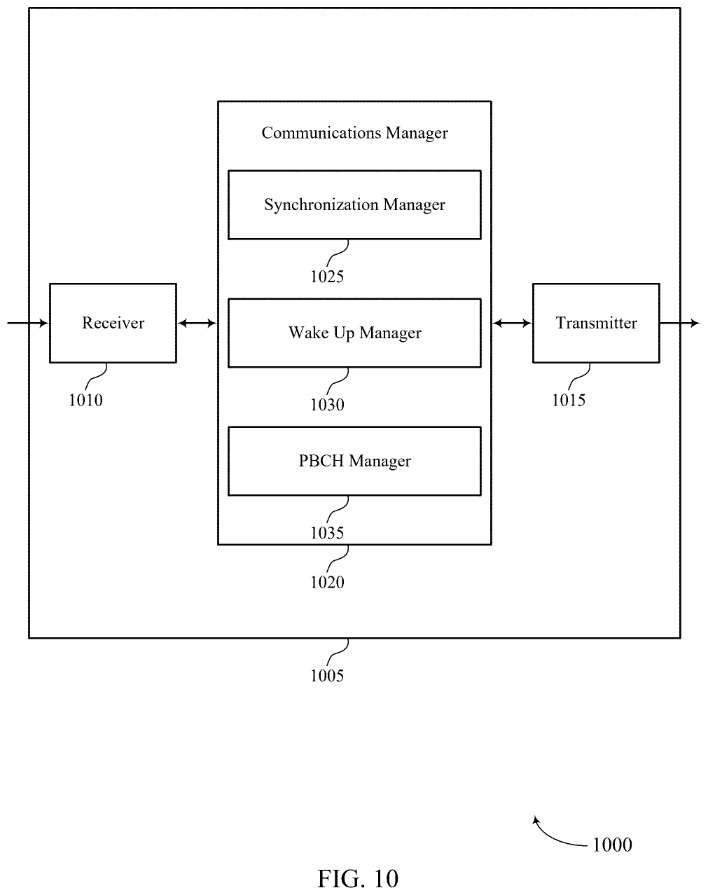

FIG. 10 shows a block diagram 1000 of a device 1005 that supports synchronization signal design for network energy savings in accordance with one or more aspects of the present disclosure. The device 1005 may be an example of aspects of a device 905 or a network node 105 as described herein. The device 1005 may include a receiver 1010, a transmitter 1015, and a communications manager 1020. The device 1005, or one or more components of the device 1005 (e.g., the receiver 1010, the transmitter 1015, the communications manager 1020), may include at least one processor, which may be coupled with at least one memory, to support the described techniques. Each of these components may be in communication with one another (e.g., via one or more buses).

The receiver 1010 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1005. In some examples, the receiver 1010 may support obtaining information by receiving signals via one or more antennas. Additionally, or alternatively, the receiver 1010 may support obtaining information by receiving signals via one or more wired (e.g., electrical, fiber optic) interfaces, wireless interfaces, or any combination thereof.

The transmitter 1015 may provide a means for outputting (e.g., transmitting, providing, conveying, sending) information generated by other components of the device 1005. For example, the transmitter 1015 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1015 may support outputting information by transmitting signals via one or more antennas. Additionally, or alternatively, the transmitter 1015 may support outputting information by transmitting signals via one or more wired (e.g., electrical, fiber optic) interfaces, wireless interfaces, or any combination thereof. In some examples, the transmitter 1015 and the receiver 1010 may be co-located in a transceiver, which may include or be coupled with a modem.

The device 1005, or various components thereof, may be an example of means for performing various aspects of synchronization signal design for network energy savings as described herein. For example, the communications manager 1020 may include a synchronization manager 1025, a wake up manager 1030, a PBCH manager 1035, or any combination thereof. The communications manager 1020 may be an example of aspects of a communications manager 920 as described herein. In some examples, the communications manager 1020, or various components thereof, may be configured to perform various operations (e.g., receiving, obtaining, monitoring, outputting, transmitting) using or otherwise in cooperation with the receiver 1010, the transmitter 1015, or both. For example, the communications manager 1020 may receive information from the receiver 1010, send information to the transmitter 1015, or be integrated in combination with the receiver 1010, the transmitter 1015, or both to obtain information, output information, or perform various other operations as described herein.

The communications manager 1020 may support wireless communications in accordance with examples as disclosed herein. The synchronization manager 1025 is capable of, configured to, or operable to support a means for outputting a synchronization signal for a cell, where the synchronization signal includes a DRSIdx corresponding to an index of the synchronization signal within a burst of synchronization signals. The wake up manager 1030 is capable of, configured to, or operable to support a means for obtaining a WUS via resources of the cell that are determined based on the DRSIdx. The PBCH manager 1035 is capable of, configured to, or operable to support a means for outputting a PBCH of the cell based on obtaining the WUS.

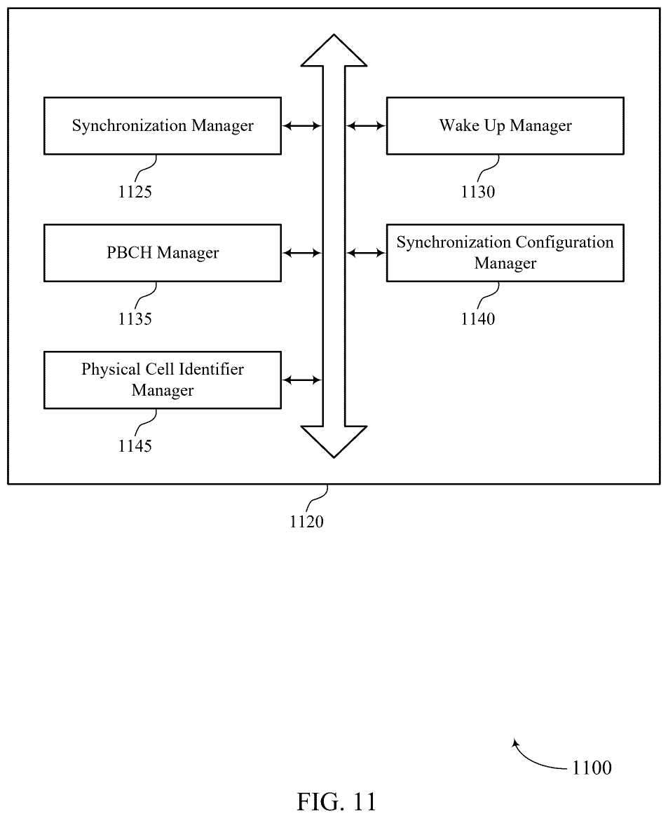

FIG. 11 shows a block diagram 1100 of a communications manager 1120 that supports synchronization signal design for network energy savings in accordance with one or more aspects of the present disclosure. The communications manager 1120 may be an example of aspects of a communications manager 920, a communications manager 1020, or both, as described herein. The communications manager 1120, or various components thereof, may be an example of means for performing various aspects of synchronization signal design for network energy savings as described herein. For example, the communications manager 1120 may include a synchronization manager 1125, a wake up manager 1130, a PBCH manager 1135, a synchronization configuration manager 1140, a PCI manager 1145, or any combination thereof. Each of these components, or components or subcomponents thereof (e.g., one or more processors, one or more memories), may communicate, directly or indirectly, with one another (e.g., via one or more buses).

The communications manager 1120 may support wireless communications in accordance with examples as disclosed herein. The synchronization manager 1125 is capable of, configured to, or operable to support a means for outputting a synchronization signal for a cell, where the synchronization signal includes a DRSIdx corresponding to an index of the synchronization signal within a burst of synchronization signals. The wake up manager 1130 is capable of, configured to, or operable to support a means for obtaining a WUS via resources of the cell that are determined based on the DRSIdx. The PBCH manager 1135 is capable of, configured to, or operable to support a means for outputting a PBCH of the cell based on obtaining the WUS.

In some examples, the synchronization manager 1125 is capable of, configured to, or operable to support a means for outputting, via the synchronization signal for the cell, a virtual cell identifier of the cell, where the virtual cell identifier is associated with a PCI of the cell.

In some examples, the PBCH includes a partial PCI. In some examples, the PCI is determined based on the partial PCI and the virtual cell identifier.

In some examples, the PCI manager 1145 is capable of, configured to, or operable to support a means for outputting, as an anchor cell, a set of PCIs corresponding to one or more cells associated with the anchor cell.

In some examples, the PCI manager 1145 is capable of, configured to, or operable to support a means for obtaining, from an anchor cell, a set of PCIs corresponding to one or more cells associated with the anchor cell.

In some examples, the virtual cell identifier includes a second index, and the second index indicates the PCI in the set of PCIs.

In some examples, the set of PCIs corresponding to the one or more cells are divided into a set of multiple subgroups. In some examples, the virtual cell identifier indicates a subgroup associated with the PCI.

In some examples, the PCI is mapped to a first network identifier and a second network identifier, and the virtual cell identifier includes the first network identifier or the second network identifier.

In some examples, the virtual cell identifier including a set of most significant bits of the PCI or a set of least significant bits of the PCI.

In some examples, a sequence associated with the synchronization signal is based on the virtual cell identifier and the DRSIdx.

In some examples, the virtual cell identifier and the DRSIdx are mapped to a first network identifier and a second network identifier associated with the synchronization signal.

In some examples, a demodulation reference signal scrambling seed associated with the PBCH is based on the virtual cell identifier or the DRSIdx.

In some examples, the PBCH includes a PCI.

In some examples, the synchronization configuration manager 1140 is capable of, configured to, or operable to support a means for obtaining, from an anchor cell, an indication of an offset, an uplink WUS length, and a synchronization signal length, where the resources of the cell are based on the offset, the uplink WUS length, and the synchronization signal length.

In some examples, the synchronization configuration manager 1140 is capable of, configured to, or operable to support a means for outputting, as an anchor cell, an indication of an offset, an uplink WUS length, and a synchronization signal length, where the resources of the cell are based on the offset, the uplink WUS length, and the synchronization signal length.

In some examples, the burst of synchronization signals are time division multiplexed based on a time gap, frequency division multiplexed based on a frequency offset, or both.

In some examples, the synchronization configuration manager 1140 is capable of, configured to, or operable to support a means for obtaining, from an anchor cell, an indication of the time gap, the frequency offset, or both.

In some examples, the synchronization configuration manager 1140 is capable of, configured to, or operable to support a means for outputting, as an anchor cell, an indication of the time gap, the frequency offset, or both.

In some examples, the synchronization configuration manager 1140 is capable of, configured to, or operable to support a means for obtaining, from an anchor cell, an indication of a packing pattern associated with the burst of synchronization signals, where outputting the synchronization signal for the cell is based on the packing pattern.

In some examples, the synchronization configuration manager 1140 is capable of, configured to, or operable to support a means for outputting, as an anchor cell, an indication of a packing pattern associated with the burst of synchronization signals, where outputting the synchronization signal for the cell is based on the packing pattern.

In some examples, the wake up manager 1130 is capable of, configured to, or operable to support a means for obtaining a second WUS via second resources of the cell that are determined based on the DRSIdx, where a transmit power associated with the second WUS is based on the second WUS being a retransmission of the WUS.

In some examples, the WUS includes a single signal.

In some examples, the WUS includes a set of multiple signals.

In some examples, data associated with the PBCH is based on the WUS.

In some examples, the WUS includes an indication of a mobility state at a UE.

In some examples, to support outputting the PBCH, the PBCH manager 1135 is capable of, configured to, or operable to support a means for outputting the PBCH via one or more transmit beams at the network node associated with the cell, where at least one of the one or more transmit beams are QCL with the synchronization signal.

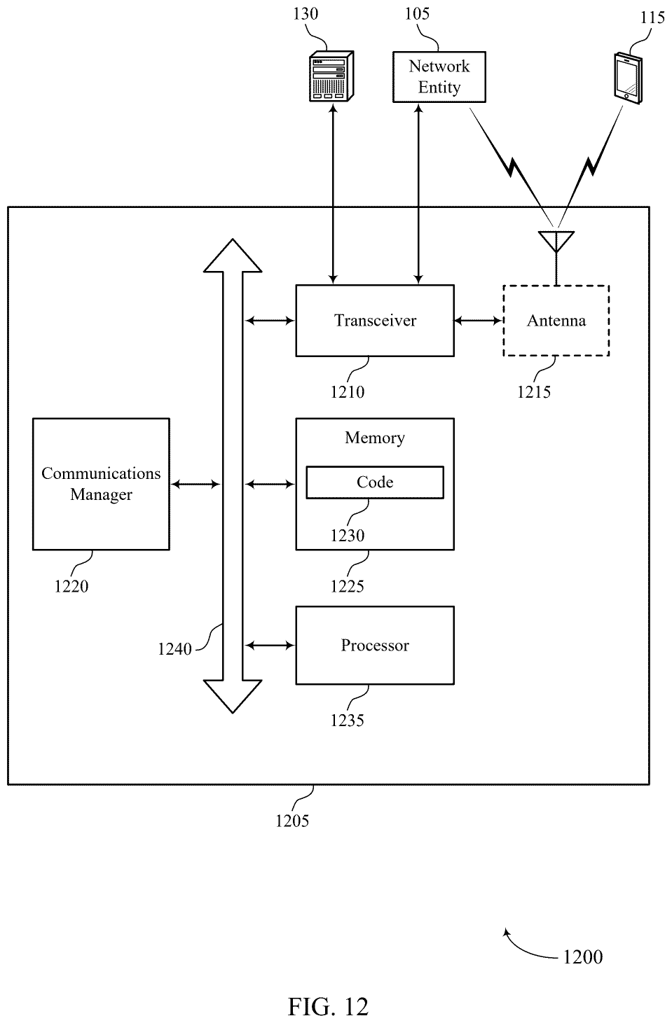

FIG. 12 shows a diagram of a system 1200 including a device 1205 that supports synchronization signal design for network energy savings in accordance with one or more aspects of the present disclosure. The device 1205 may be an example of or include components of a device 905, a device 1005, or a network node as described herein. The device 1205 may include components for bi-directional voice and data communications including components for transmitting and receiving communications, such as a communications manager 1220, a transceiver 1210, one or more antennas 1215, at least one memory 1225, code 1230, and at least one processor 1235. These components may be in electronic communication or otherwise coupled (e.g., operatively, communicatively, functionally, electronically, electrically) via one or more buses (e.g., a bus 1240).

The transceiver 1210 may support bi-directional communications via wired links, wireless links, or both as described herein. In some examples, the transceiver 1210 may include a wired transceiver and may communicate bi-directionally with another wired transceiver. Additionally, or alternatively, in some examples, the transceiver 1210 may include a wireless transceiver and may communicate bi-directionally with another wireless transceiver. In some examples, the device 1205 may include one or more antennas 1215, which may be capable of transmitting or receiving wireless transmissions (e.g., concurrently). The transceiver 1210 may also include a modem to modulate signals, to provide the modulated signals for transmission (e.g., by one or more antennas 1215, by a wired transmitter), to receive modulated signals (e.g., from one or more antennas 1215, from a wired receiver), and to demodulate signals. In some implementations, the transceiver 1210 may include one or more interfaces, such as one or more interfaces coupled with the one or more antennas 1215 that are configured to support various receiving or obtaining operations, or one or more interfaces coupled with the one or more antennas 1215 that are configured to support various transmitting or outputting operations, or a combination thereof. In some implementations, the transceiver 1210 may include or be configured for coupling with one or more processors or one or more memory components that are operable to perform or support operations based on received or obtained information or signals, or to generate information or other signals for transmission or other outputting, or any combination thereof. In some implementations, the transceiver 1210, or the transceiver 1210 and the one or more antennas 1215, or the transceiver 1210 and the one or more antennas 1215 and one or more processors or one or more memory components (e.g., the at least one processor 1235, the at least one memory 1225, or both), may be included in a chip or chip assembly that is installed in the device 1205. In some examples, the transceiver 1210 may be operable to support communications via one or more communications links (e.g., communication link(s) 125, backhaul communication link(s) 120, a midhaul communication link 162, a fronthaul communication link 168).

The at least one memory 1225 may include RAM, ROM, or any combination thereof. The at least one memory 1225 may store computer-readable, computer-executable, or processor-executable code, such as the code 1230. The code 1230 may include instructions that, when executed by one or more of the at least one processor 1235, cause the device 1205 to perform various functions described herein. The code 1230 may be stored in a non-transitory computer-readable medium such as system memory or another type of memory. In some cases, the code 1230 may not be directly executable by a processor of the at least one processor 1235 but may cause a computer (e.g., when compiled and executed) to perform functions described herein. In some cases, the at least one memory 1225 may include, among other things, a BIOS which may control basic hardware or software operation such as the interaction with peripheral components or devices. In some examples, the at least one processor 1235 may include multiple processors and the at least one memory 1225 may include multiple memories. One or more of the multiple processors may be coupled with one or more of the multiple memories which may, individually or collectively, be configured to perform various functions herein (for example, as part of a processing system).

The at least one processor 1235 may include one or more intelligent hardware devices (e.g., one or more general-purpose processors, one or more DSPs, one or more CPUs, one or more graphics processing units (GPUs), one or more neural processing units (NPUs) (also referred to as neural network processors or deep learning processors (DLPs)), one or more microcontrollers, one or more ASICs, one or more FPGAs, one or more programmable logic devices, discrete gate or transistor logic, one or more discrete hardware components, or any combination thereof). In some cases, the at least one processor 1235 may be configured to operate a memory array using a memory controller. In some other cases, a memory controller may be integrated into one or more of the at least one processor 1235. The at least one processor 1235 may be configured to execute computer-readable instructions stored in a memory (e.g., one or more of the at least one memory 1225) to cause the device 1205 to perform various functions (e.g., functions or tasks supporting synchronization signal design for network energy savings). For example, the device 1205 or a component of the device 1205 may include at least one processor 1235 and at least one memory 1225 coupled with one or more of the at least one processor 1235, the at least one processor 1235 and the at least one memory 1225 configured to perform various functions described herein. The at least one processor 1235 may be an example of a cloud-computing platform (e.g., one or more physical nodes and supporting software such as operating systems, virtual machines, or container instances) that may host the functions (e.g., by executing code 1230) to perform the functions of the device 1205. The at least one processor 1235 may be any one or more suitable processors capable of executing scripts or instructions of one or more software programs stored in the device 1205 (such as within one or more of the at least one memory 1225).

In some examples, the at least one processor 1235 may include multiple processors and the at least one memory 1225 may include multiple memories. One or more of the multiple processors may be coupled with one or more of the multiple memories, which may, individually or collectively, be configured to perform various functions herein. In some examples, the at least one processor 1235 may be a component of a processing system, which may refer to a system (such as a series) of machines, circuitry (including, for example, one or both of processor circuitry (which may include the at least one processor 1235) and memory circuitry (which may include the at least one memory 1225)), or components, that receives or obtains inputs and processes the inputs to produce, generate, or obtain a set of outputs. The processing system may be configured to perform one or more of the functions described herein. For example, the at least one processor 1235 or a processing system including the at least one processor 1235 may be configured to, configurable to, or operable to cause the device 1205 to perform one or more of the functions described herein. Further, as described herein, being “configured to,” being “configurable to,” and being “operable to” may be used interchangeably and may be associated with a capability, when executing code stored in the at least one memory 1225 or otherwise, to perform one or more of the functions described herein.

In some examples, a bus 1240 may support communications of (e.g., within) a protocol layer of a protocol stack. In some examples, a bus 1240 may support communications associated with a logical channel of a protocol stack (e.g., between protocol layers of a protocol stack), which may include communications performed within a component of the device 1205, or between different components of the device 1205 that may be co-located or located in different locations (e.g., where the device 1205 may refer to a system in which one or more of the communications manager 1220, the transceiver 1210, the at least one memory 1225, the code 1230, and the at least one processor 1235 may be located in one of the different components or divided between different components).

In some examples, the communications manager 1220 may manage aspects of communications with a core network 130 (e.g., via one or more wired or wireless backhaul links). For example, the communications manager 1220 may manage the transfer of data communications for client devices, such as one or more UEs 115. In some examples, the communications manager 1220 may manage communications with one or more other network nodes 105, and may include a controller or scheduler for controlling communications with UEs 115 (e.g., in cooperation with the one or more other network devices). In some examples, the communications manager 1220 may support an X2 interface within an LTE/LTE-A wireless communications network technology to provide communication between network nodes 105.

The communications manager 1220 may support wireless communications in accordance with examples as disclosed herein. For example, the communications manager 1220 is capable of, configured to, or operable to support a means for outputting a synchronization signal for a cell, where the synchronization signal includes a DRSIdx corresponding to an index of the synchronization signal within a burst of synchronization signals. The communications manager 1220 is capable of, configured to, or operable to support a means for obtaining a WUS via resources of the cell that are determined based on the DRSIdx. The communications manager 1220 is capable of, configured to, or operable to support a means for outputting a PBCH of the cell based on obtaining the WUS.

By including or configuring the communications manager 1220 in accordance with examples as described herein, the device 1205 may support techniques for reduced power consumption, more efficient utilization of communication resources, improved coordination between devices, and the like.

In some examples, the communications manager 1220 may be configured to perform various operations (e.g., receiving, obtaining, monitoring, outputting, transmitting) using or otherwise in cooperation with the transceiver 1210, the one or more antennas 1215 (e.g., where applicable), or any combination thereof. Although the communications manager 1220 is illustrated as a separate component, in some examples, one or more functions described with reference to the communications manager 1220 may be supported by or performed by the transceiver 1210, one or more of the at least one processor 1235, one or more of the at least one memory 1225, the code 1230, or any combination thereof (for example, by a processing system including at least a portion of the at least one processor 1235, the at least one memory 1225, the code 1230, or any combination thereof). For example, the code 1230 may include instructions executable by one or more of the at least one processor 1235 to cause the device 1205 to perform various aspects of synchronization signal design for network energy savings as described herein, or the at least one processor 1235 and the at least one memory 1225 may be otherwise configured to, individually or collectively, perform or support such operations.

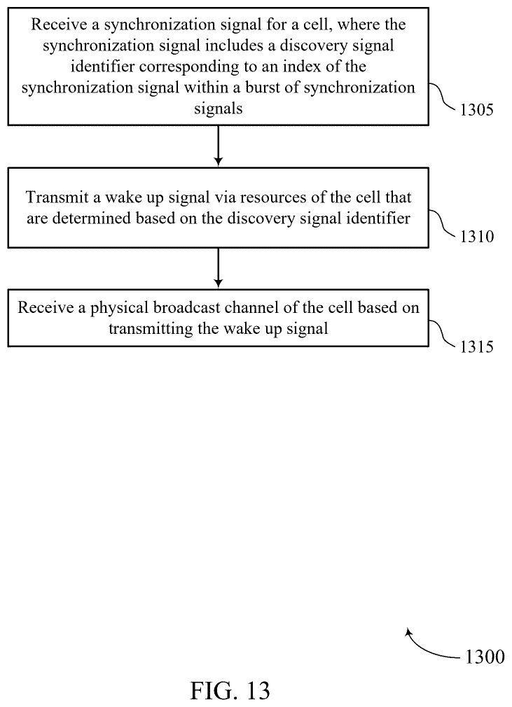

FIG. 13 shows a flowchart illustrating a method 1300 that supports synchronization signal design for network energy savings in accordance with one or more aspects of the present disclosure. The operations of the method 1300 may be implemented by a UE or its components as described herein. For example, the operations of the method 1300 may be performed by a UE 115 as described with reference to FIGS. 1 through 8. In some examples, a UE may execute a set of instructions to control the functional elements of the UE to perform the described functions. Additionally, or alternatively, the UE may perform aspects of the described functions using special-purpose hardware.

At 1305, the method may include receiving a synchronization signal for a cell, where the synchronization signal includes a DRSIdx corresponding to an index of the synchronization signal within a burst of synchronization signals. The operations of 1305 may be performed in accordance with examples as disclosed herein. In some examples, aspects of the operations of 1305 may be performed by a synchronization component 725 as described with reference to FIG. 7.

At 1310, the method may include transmitting a WUS via resources of the cell that are determined based on the DRSIdx. The operations of 1310 may be performed in accordance with examples as disclosed herein. In some examples, aspects of the operations of 1310 may be performed by a wake up component 730 as described with reference to FIG. 7.

At 1315, the method may include receiving a PBCH of the cell based on transmitting the WUS. The operations of 1315 may be performed in accordance with examples as disclosed herein. In some examples, aspects of the operations of 1315 may be performed by a PBCH component 735 as described with reference to FIG. 7.

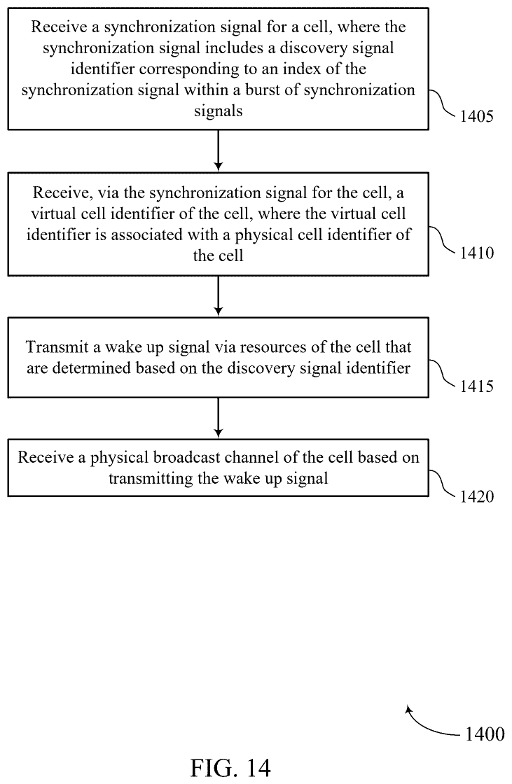

FIG. 14 shows a flowchart illustrating a method 1400 that supports synchronization signal design for network energy savings in accordance with one or more aspects of the present disclosure. The operations of the method 1400 may be implemented by a UE or its components as described herein. For example, the operations of the method 1400 may be performed by a UE 115 as described with reference to FIGS. 1 through 8. In some examples, a UE may execute a set of instructions to control the functional elements of the UE to perform the described functions. Additionally, or alternatively, the UE may perform aspects of the described functions using special-purpose hardware.

At 1405, the method may include receiving a synchronization signal for a cell, where the synchronization signal includes a DRSIdx corresponding to an index of the synchronization signal within a burst of synchronization signals. The operations of 1405 may be performed in accordance with examples as disclosed herein. In some examples, aspects of the operations of 1405 may be performed by a synchronization component 725 as described with reference to FIG. 7.

At 1410, the method may include receiving, via the synchronization signal for the cell, a virtual cell identifier of the cell, where the virtual cell identifier is associated with a PCI of the cell. The operations of 1410 may be performed in accordance with examples as disclosed herein. In some examples, aspects of the operations of 1410 may be performed by a synchronization component 725 as described with reference to FIG. 7.

At 1415, the method may include transmitting a WUS via resources of the cell that are determined based on the DRSIdx. The operations of 1415 may be performed in accordance with examples as disclosed herein. In some examples, aspects of the operations of 1415 may be performed by a wake up component 730 as described with reference to FIG. 7.

At 1420, the method may include receiving a PBCH of the cell based on transmitting the WUS. The operations of 1420 may be performed in accordance with examples as disclosed herein. In some examples, aspects of the operations of 1420 may be performed by a PBCH component 735 as described with reference to FIG. 7.

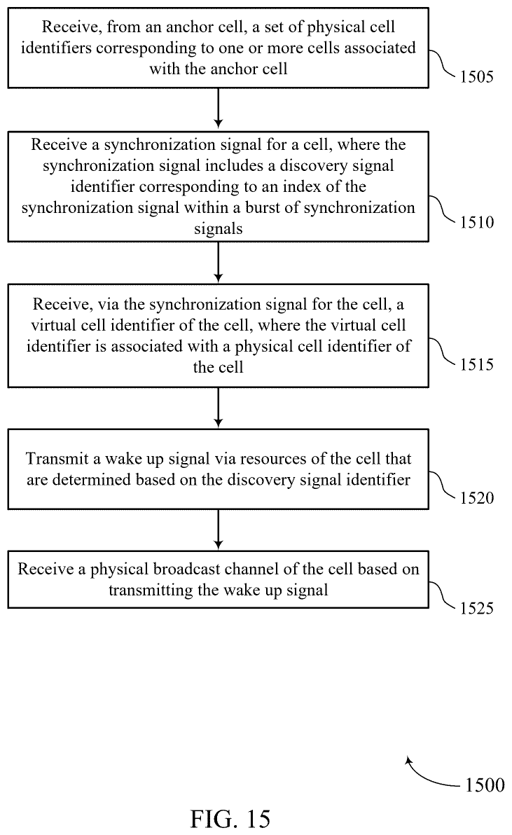

FIG. 15 shows a flowchart illustrating a method 1500 that supports synchronization signal design for network energy savings in accordance with one or more aspects of the present disclosure. The operations of the method 1500 may be implemented by a UE or its components as described herein. For example, the operations of the method 1500 may be performed by a UE 115 as described with reference to FIGS. 1 through 8. In some examples, a UE may execute a set of instructions to control the functional elements of the UE to perform the described functions. Additionally, or alternatively, the UE may perform aspects of the described functions using special-purpose hardware.

At 1505, the method may include receiving, from an anchor cell, a set of PCIs corresponding to one or more cells associated with the anchor cell. The operations of 1505 may be performed in accordance with examples as disclosed herein. In some examples, aspects of the operations of 1505 may be performed by a PCI component 745 as described with reference to FIG. 7.

At 1510, the method may include receiving a synchronization signal for a cell, where the synchronization signal includes a DRSIdx corresponding to an index of the synchronization signal within a burst of synchronization signals. The operations of 1510 may be performed in accordance with examples as disclosed herein. In some examples, aspects of the operations of 1510 may be performed by a synchronization component 725 as described with reference to FIG. 7.

At 1515, the method may include receiving, via the synchronization signal for the cell, a virtual cell identifier of the cell, where the virtual cell identifier is associated with a PCI of the cell. The operations of 1515 may be performed in accordance with examples as disclosed herein. In some examples, aspects of the operations of 1515 may be performed by a synchronization component 725 as described with reference to FIG. 7.

At 1520, the method may include transmitting a WUS via resources of the cell that are determined based on the DRSIdx. The operations of 1520 may be performed in accordance with examples as disclosed herein. In some examples, aspects of the operations of 1520 may be performed by a wake up component 730 as described with reference to FIG. 7.

At 1525, the method may include receiving a PBCH of the cell based on transmitting the WUS. The operations of 1525 may be performed in accordance with examples as disclosed herein. In some examples, aspects of the operations of 1525 may be performed by a PBCH component 735 as described with reference to FIG. 7.

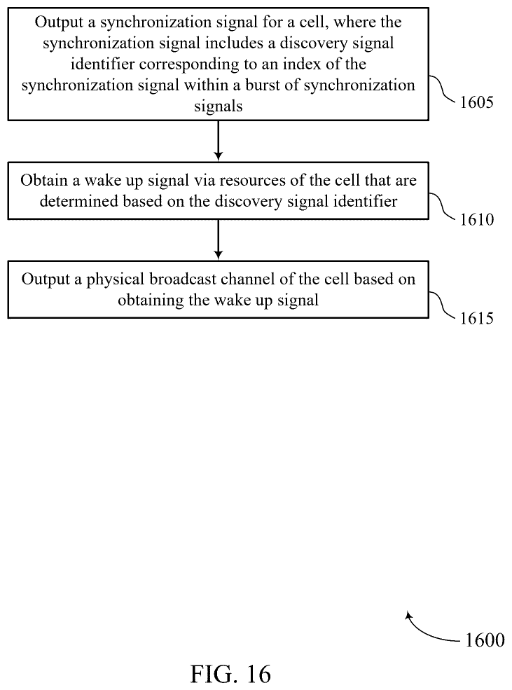

FIG. 16 shows a flowchart illustrating a method 1600 that supports synchronization signal design for network energy savings in accordance with one or more aspects of the present disclosure. The operations of the method 1600 may be implemented by a network node or its components as described herein. For example, the operations of the method 1600 may be performed by a network node as described with reference to FIGS. 1 through 4 and 9 through 12. In some examples, a network node may execute a set of instructions to control the functional elements of the network node to perform the described functions. Additionally, or alternatively, the network node may perform aspects of the described functions using special-purpose hardware.

At 1605, the method may include outputting a synchronization signal for a cell, where the synchronization signal includes a DRSIdx corresponding to an index of the synchronization signal within a burst of synchronization signals. The operations of 1605 may be performed in accordance with examples as disclosed herein. In some examples, aspects of the operations of 1605 may be performed by a synchronization manager 1125 as described with reference to FIG. 11.

At 1610, the method may include obtaining a WUS via resources of the cell that are determined based on the DRSIdx. The operations of 1610 may be performed in accordance with examples as disclosed herein. In some examples, aspects of the operations of 1610 may be performed by a wake up manager 1130 as described with reference to FIG. 11.

At 1615, the method may include outputting a PBCH of the cell based on obtaining the WUS. The operations of 1615 may be performed in accordance with examples as disclosed herein. In some examples, aspects of the operations of 1615 may be performed by a PBCH manager 1135 as described with reference to FIG. 11.

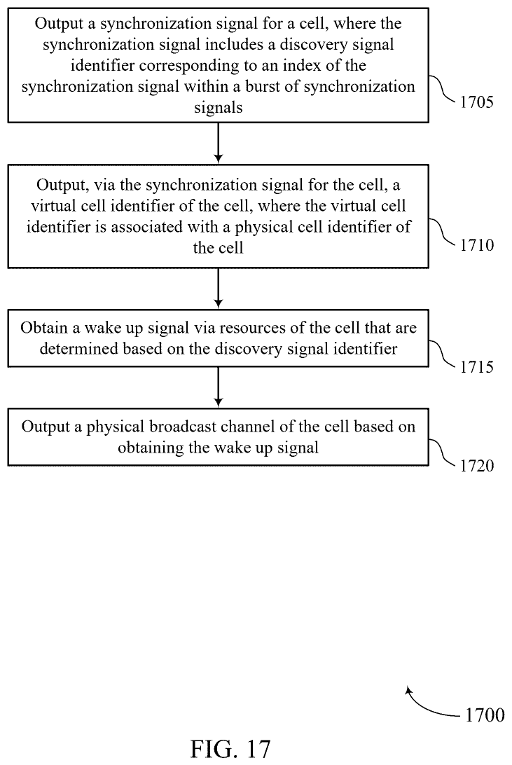

FIG. 17 shows a flowchart illustrating a method 1700 that supports synchronization signal design for network energy savings in accordance with one or more aspects of the present disclosure. The operations of the method 1700 may be implemented by a network node or its components as described herein. For example, the operations of the method 1700 may be performed by a network node as described with reference to FIGS. 1 through 4 and 9 through 12. In some examples, a network node may execute a set of instructions to control the functional elements of the network node to perform the described functions. Additionally, or alternatively, the network node may perform aspects of the described functions using special-purpose hardware.

At 1705, the method may include outputting a synchronization signal for a cell, where the synchronization signal includes a DRSIdx corresponding to an index of the synchronization signal within a burst of synchronization signals. The operations of 1705 may be performed in accordance with examples as disclosed herein. In some examples, aspects of the operations of 1705 may be performed by a synchronization manager 1125 as described with reference to FIG. 11.

At 1710, the method may include outputting, via the synchronization signal for the cell, a virtual cell identifier of the cell, where the virtual cell identifier is associated with a PCI of the cell. The operations of 1710 may be performed in accordance with examples as disclosed herein. In some examples, aspects of the operations of 1710 may be performed by a synchronization manager 1125 as described with reference to FIG. 11.

At 1715, the method may include obtaining a WUS via resources of the cell that are determined based on the DRSIdx. The operations of 1715 may be performed in accordance with examples as disclosed herein. In some examples, aspects of the operations of 1715 may be performed by a wake up manager 1130 as described with reference to FIG. 11.

At 1720, the method may include outputting a PBCH of the cell based on obtaining the WUS. The operations of 1720 may be performed in accordance with examples as disclosed herein. In some examples, aspects of the operations of 1720 may be performed by a PBCH manager 1135 as described with reference to FIG. 11.

The following provides an overview of aspects of the present disclosure:

Aspect 1: A method by a UE, comprising: receiving a synchronization signal for a cell, wherein the synchronization signal comprises a discovery signal identifier (e.g., DRSIdx) corresponding to an index of the synchronization signal within a burst of synchronization signals; transmitting a WUS via resources of the cell that are determined based at least in part on the discovery signal identifier; and receiving a PBCH of the cell based at least in part on transmitting the WUS.

Aspect 2: The method of aspect 1, further comprising: receiving, via the synchronization signal for the cell, a virtual cell identifier of the cell, wherein the virtual cell identifier is associated with a PCI of the cell.

Aspect 3: The method of aspect 2, wherein the PBCH comprises a partial PCI, and the PCI is determined based at least in part on the partial PCI and the virtual cell identifier.

Aspect 4: The method of aspect 2, further comprising: receiving, from an anchor cell, a set of PCIs corresponding to one or more cells associated with the anchor cell.

Aspect 5: The method of aspect 4, wherein the virtual cell identifier comprises a second index, and the second index indicates the PCI in the set of PCIs.

Aspect 6: The method of aspect 4, wherein the set of PCIs corresponding to the one or more cells are divided into a plurality of subgroups, and the virtual cell identifier indicates a subgroup associated with the PCI.

Aspect 7: The method of aspect 2, wherein the PCI is mapped to a first NID and a second NID, and the virtual cell identifier comprises the first NID or the second NID.

Aspect 8: The method of aspect 2, wherein the virtual cell identifier corresponds to a set of most significant bits of the PCI or a set of least significant bits of the PCI.

Aspect 9: The method of any of aspects 2 through 8, wherein a sequence associated with the synchronization signal is based at least in part on the virtual cell identifier and the discovery signal identifier.

Aspect 10: The method of any of aspects 2 through 9, wherein the virtual cell identifier and the discovery signal identifier are mapped to a first NID and a second NID associated with the synchronization signal.

Aspect 11: The method of any of aspects 2 through 10, wherein a demodulation reference signal scrambling seed associated with the PBCH is based at least in part on the virtual cell identifier or the discovery signal identifier.

Aspect 12: The method of any of aspects 1 through 11, wherein the PBCH comprises a PCI.

Aspect 13: The method of any of aspects 1 through 12, further comprising:

receiving, from an anchor cell, an indication of an offset, an uplink WUS length, and a synchronization signal length, wherein the resources of the cell are based at least in part on the offset, the uplink WUS length, and the synchronization signal length.

Aspect 14: The method of any of aspects 1 through 13, wherein the burst of synchronization signals are TDMed based at least in part on a time gap, FDMed based at least in part on a frequency offset, or both.

Aspect 15: The method of aspect 14, further comprising: receiving, from an anchor cell, an indication of the time gap, the frequency offset, or both.

Aspect 16: The method of any of aspects 1 through 15, further comprising: receiving, from an anchor cell, an indication of a packing pattern associated with the burst of synchronization signals, wherein receiving the synchronization signal for the cell is based at least in part on the packing pattern.

Aspect 17: The method of any of aspects 1 through 16, further comprising: transmitting a second WUS via second resources of the cell that are determined based at least in part on the discovery signal identifier, wherein a transmit power associated with the second WUS is based at least in part on the second WUS being a retransmission of the WUS.

Aspect 18: The method of any of aspects 1 through 17, wherein the WUS comprises a single signal.

Aspect 19: The method of any of aspects 1 through 17, wherein the WUS comprises a plurality of signals.

Aspect 20: The method of any of aspects 1 through 19, wherein data associated with the PBCH is based at least in part on the WUS.

Aspect 21: The method of any of aspects 1 through 20, wherein the WUS comprises an indication of a mobility state at the UE.

Aspect 22: The method of any of aspects 1 through 21, wherein to receiving the PBCH further comprises: receiving the PBCH via one or more transmit beams at a network node associated with the cell, wherein at least one of the one or more transmit beams are quasi collocated with the synchronization signal.

Aspect 23: A method by a network node, comprising: outputting a synchronization signal for a cell, wherein the synchronization signal comprises a discovery signal identifier corresponding to an index of the synchronization signal within a burst of synchronization signals; obtaining a WUS via resources of the cell that are determined based at least in part on the discovery signal identifier; and outputting a PBCH of the cell based at least in part on obtaining the WUS.

Aspect 24: The method of aspect 23, further comprising: output, via the synchronization signal for the cell, a virtual cell identifier of the cell, wherein the virtual cell identifier being associated with a PCI of the cell.

Aspect 25: The method of any of aspects 23 through 24, further comprising: obtaining, from an anchor cell, an indication of an offset, an uplink WUS length, and a synchronization signal length, wherein the resources of the cell are based at least in part on the offset, the uplink WUS length, and the synchronization signal length.

Aspect 26: The method of any of aspects 23 through 25, further comprising: output, as an anchor cell, an indication of an offset, an uplink waking up signal length, and a synchronization signal length, wherein the resources of the cell are based at least in part on the offset, the uplink WUS length, and the synchronization signal length.

Aspect 27: The method of any of aspects 23 through 26, further comprising: obtaining, from an anchor cell, an indication of a packing pattern associated with the burst of synchronization signals, wherein outputting the synchronization signal for the cell is based at least in part on the packing pattern.

Aspect 28: The method of any of aspects 23 through 27, further comprising: output, as an anchor cell, an indication of a packing pattern associating with the burst of synchronization signals, wherein outputting the synchronization signal for the cell is based at least in part on the packing pattern.

Aspect 29: A UE comprising one or more memories storing processor-executable code, and one or more processors coupled with the one or more memories and individually or collectively operable to execute the code to cause the UE to perform a method of any of aspects 1 through 22.

Aspect 30: A UE comprising at least one means for performing a method of any of aspects 1 through 22.

Aspect 31: A non-transitory computer-readable medium storing code the code comprising instructions executable by one or more processors to perform a method of any of aspects 1 through 22.

Aspect 32: A network node comprising one or more memories storing processor-executable code, and one or more processors coupled with the one or more memories and individually or collectively operable to execute the code to cause the network node to perform a method of any of aspects 23 through 28.

Aspect 33: A network node comprising at least one means for performing a method of any of aspects 23 through 28.

Aspect 34: A non-transitory computer-readable medium storing code the code comprising instructions executable by one or more processors to perform a method of any of aspects 23 through 28.

It should be noted that the methods described herein describe possible implementations. The operations and the steps may be rearranged or otherwise modified and other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, a graphics processing unit (GPU), a neural processing unit (NPU), an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Any functions or operations described herein as being capable of being performed by a processor may be performed by multiple processors that, individually or collectively, are capable of performing the described functions or operations.

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk, and Blu-ray disc. Disks may reproduce data magnetically, and discs may reproduce data optically using lasers. Combinations of the above are also included within the scope of computer-readable media. Any functions or operations described herein as being capable of being performed by a memory may be performed by multiple memories that, individually or collectively, are capable of performing the described functions or operations.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

As used herein, including in the claims, the article “a” before a noun is open-ended and understood to refer to “at least one” of those nouns or “one or more” of those nouns. Thus, the terms “a,” “at least one,” “one or more,” and “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

The term “determine” or “determining” encompasses a variety of actions and, therefore, “determining” can include calculating, computing, processing, deriving, investigating, looking up (such as via looking up in a table, a database, or another data structure), ascertaining, and the like. Also, “determining” can include receiving (e.g., receiving information), accessing (e.g., accessing data stored in memory), and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label or other subsequent reference label.

The description set forth herein, in connection with the appended drawings, describes example configurations and does not represent all the examples that may be implemented or that are within the scope of the claims. The term “example” used herein means “serving as an example, instance, or illustration” and not “preferred” or “advantageous over other examples.” The detailed description includes specific details for the purpose of providing an understanding of the described techniques. These techniques, however, may be practiced without these specific details. In some figures, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A user equipment (UE), comprising:
one or more memories storing processor-executable code; and
one or more processors coupled with the one or more memories and individually or collectively operable to execute the code to cause the UE to:
receive a synchronization signal for a cell, wherein the synchronization signal comprises a discovery signal identifier corresponding to an index of the synchronization signal within a burst of synchronization signals;
transmit a wake up signal via resources of the cell that are determined based at least in part on the discovery signal identifier; and
receive a physical broadcast channel of the cell based at least in part on transmitting the wake up signal.

2. The UE of claim 1, wherein the one or more processors are individually or collectively further operable to execute the code to cause the UE to:
receive, via the synchronization signal for the cell, a virtual cell identifier of the cell, wherein the virtual cell identifier is associated with a physical cell identifier of the cell.

3. The UE of claim 2, wherein:
the physical broadcast channel comprises a partial physical cell identifier, and
the physical cell identifier is determined based at least in part on the partial physical cell identifier and the virtual cell identifier.

4. The UE of claim 2, wherein the one or more processors are individually or collectively further operable to execute the code to cause the UE to:
receive, from an anchor cell, a set of physical cell identifiers corresponding to one or more cells associated with the anchor cell.

5. The UE of claim 4, wherein the virtual cell identifier comprises a second index, and the second index indicates the physical cell identifier in the set of physical cell identifiers.

6. The UE of claim 4, wherein:
the set of physical cell identifiers corresponding to the one or more cells are divided into a plurality of subgroups, and
the virtual cell identifier indicates a subgroup associated with the physical cell identifier.

7. The UE of claim 2, wherein the physical cell identifier is mapped to a first network identifier and a second network identifier, and the virtual cell identifier comprises the first network identifier or the second network identifier.

8. The UE of claim 2, wherein the virtual cell identifier corresponds to a set of most significant bits of the physical cell identifier or a set of least significant bits of the physical cell identifier.

9. The UE of claim 2, wherein a sequence associated with the synchronization signal is based at least in part on the virtual cell identifier and the discovery signal identifier.

10. The UE of claim 2, wherein the virtual cell identifier and the discovery signal identifier are mapped to a first network identifier and a second network identifier associated with the synchronization signal.

11. The UE of claim 2, wherein a demodulation reference signal scrambling seed associated with the physical broadcast channel is based at least in part on the virtual cell identifier or the discovery signal identifier.

12. The UE of claim 1, wherein the physical broadcast channel comprises a physical cell identifier.

13. The UE of claim 1, wherein the one or more processors are individually or collectively further operable to execute the code to cause the UE to:
receive, from an anchor cell, an indication of an offset, an uplink wake up signal length, and a synchronization signal length, wherein the resources of the cell are based at least in part on the offset, the uplink wake up signal length, and the synchronization signal length.

14. The UE of claim 1, wherein the burst of synchronization signals are time division multiplexed based at least in part on a time gap, frequency division multiplexed based at least in part on a frequency offset, or both.

15. The UE of claim 14, wherein the one or more processors are individually or collectively further operable to execute the code to cause the UE to:
receive, from an anchor cell, an indication of the time gap, the frequency offset, or both.

16. The UE of claim 1, wherein the one or more processors are individually or collectively further operable to execute the code to cause the UE to:
receive, from an anchor cell, an indication of a packing pattern associated with the burst of synchronization signals, wherein receiving the synchronization signal for the cell is based at least in part on the packing pattern.

17. The UE of claim 1, wherein the one or more processors are individually or collectively further operable to execute the code to cause the UE to:
transmit a second wake up signal via second resources of the cell that are determined based at least in part on the discovery signal identifier, wherein a transmit power associated with the second wake up signal is based at least in part on the second wake up signal being a retransmission of the wake up signal.

18. The UE of claim 1, wherein the wake up signal comprises a single signal.

19. The UE of claim 1, wherein the wake up signal comprises a plurality of signals.

20. The UE of claim 1, wherein data associated with the physical broadcast channel is based at least in part on the wake up signal.

21. The UE of claim 1, wherein the wake up signal comprises an indication of a mobility state at the UE.

22. The UE of claim 1, wherein, to receive the physical broadcast channel, the one or more processors are individually or collectively further operable to execute the code to cause the UE to:
receive the physical broadcast channel via one or more transmit beams at a network node associated with the cell, wherein at least one of the one or more transmit beams are quasi collocated with the synchronization signal.

23. A network node, comprising:
one or more memories storing processor-executable code; and
one or more processors coupled with the one or more memories and individually or collectively operable to execute the code to cause the network node to:
output a synchronization signal for a cell, wherein the synchronization signal comprises a discovery signal identifier corresponding to an index of the synchronization signal within a burst of synchronization signals;
obtain a wake up signal via resources of the cell that are determined based at least in part on the discovery signal identifier; and
output a physical broadcast channel of the cell based at least in part on obtaining the wake up signal.

24. The network node of claim 23, wherein the one or more processors are individually or collectively further operable to execute the code to cause the network node to:
output, via the synchronization signal for the cell, a virtual cell identifier of the cell, wherein the virtual cell identifier is associated with a physical cell identifier of the cell.

25. The network node of claim 23, wherein the one or more processors are individually or collectively further operable to execute the code to cause the network node to:
obtain, from an anchor cell, an indication of an offset, an uplink wake up signal length, and a synchronization signal length, wherein the resources of the cell are based at least in part on the offset, the uplink wake up signal length, and the synchronization signal length.

26. The network node of claim 23, wherein the one or more processors are individually or collectively further operable to execute the code to cause the network node to:
output, as an anchor cell, an indication of an offset, an uplink wake up signal length, and a synchronization signal length, wherein the resources of the cell are based at least in part on the offset, the uplink wake up signal length, and the synchronization signal length.

27. The network node of claim 23, wherein the one or more processors are individually or collectively further operable to execute the code to cause the network node to:
obtain, from an anchor cell, an indication of a packing pattern associated with the burst of synchronization signals, wherein outputting the synchronization signal for the cell is based at least in part on the packing pattern.

28. The network node of claim 23, wherein the one or more processors are individually or collectively further operable to execute the code to cause the network node to:
output, as an anchor cell, an indication of a packing pattern associated with the burst of synchronization signals, wherein outputting the synchronization signal for the cell is based at least in part on the packing pattern.

29. A method for wireless communications at a user equipment (UE), comprising:
receiving a synchronization signal for a cell, wherein the synchronization signal comprises a discovery signal identifier corresponding to an index of the synchronization signal within a burst of synchronization signals;
transmitting a wake up signal via resources of the cell that are determined based at least in part on the discovery signal identifier; and
receiving a physical broadcast channel of the cell based at least in part on transmitting the wake up signal.

30. A method for wireless communications at a network node, comprising:
outputting a synchronization signal for a cell, wherein the synchronization signal comprises a discovery signal identifier corresponding to an index of the synchronization signal within a burst of synchronization signals;
obtaining a wake up signal via resources of the cell that are determined based at least in part on the discovery signal identifier, and
outputting a physical broadcast channel of the cell based at least in part on obtaining the wake up signal.
